(19) United States
(12) Patent Application Publication
(10) Pub. No.: US 2008/0258335 A1
(43) Pub. Date: Oct. 23, 2008

(54) CASTING UNIT, DOPE APPLYING METHOD, AND SOLUTION CASTING METHOD

(76) Inventor: Daisaku ABIRU, Kanagawa (JP)

Correspondence Address: BIRCH STEWART KOLASCH & BIRCH, PO BOX 747, FALLS CHURCH, VA, 22040-0747, US

(21) Appl. No.: 12/058,109

(22) Filed: Mar. 28, 2008

(30) Foreign Application Priority Data
Mar. 29, 2007 (JP) 2007-087585
Sep. 18, 2007 (JP) 2007-240845

(51) Int. Cl. B29D 7/01

(52) U.S. Cl. 264/216; 425/224

(57) ABSTRACT

A casting die for casting a joint dope constructed of a main dope and a substantial dope has a side plate, an inner deckle plate, an inlet and an outlet. The inner deckle plate has a contact face forming an inner wall of the slot. The first dope is fed through a manifold into a slot connecting the inlet and the outlet. The second dope is fed through a pipe into a passage formed in the inner deckle plate. The passage may be connected to the slit. The inner deckle plate has a partitioning portion for partitioning the second path from the slit. The partitioning portion has an end having acute angle.

### FIELD OF THE INVENTION

The present invention relates to a casting die, a dope applying method, and a solution casting method.

### BACKGROUND OF THE INVENTION

A polymer film (hereinafter, film) is used as an optical functional film in several fields, since being excellent in the optical transparency and the flexibility and being to be smaller in weight and thickness. In the polymer film, there is a cellulose acylate film formed from cellulose acylate. For example, especially cellulose triacetate (hereinafter TAC) film is formed from TAC whose averaged acetylation degree is in the range of 57.5% to 62.5%. The TAC film is used as a film base of a film material, such as a photosensitive material, since having strength and inflammability. Further, the TAC film is excellent in optical isotropy, and therefore used as an optical functional film, such as an optical compensation film, a view angle film, a protective film for a polarizing plate in a liquid crystal display whose market becomes larger in recent years, and the like.

In the film production method, there are a melt extrusion method and a solution casting method. In the melt extrusion method, the polymer is heated to melt, and then the melt polymer is extruded to form a film. The melt extrusion method has merits in that the productivity is high and the cost for equipments is relatively low. However, it is difficult to adjust the accuracy of the film thickness, and streak (called die line) are easily formed. Therefore, by the melt extrusion method, it is hard to produce the high quality film which can be used as the optical functional film. In the solution casting method, a dope containing the polymer and a solvent is cast onto a support to form a casting film, and the casting film, after having self supporting properties, is peeled as a wet film peeled from the support. The wet film is dried to a film and then the film is wound up. The solution casting method is more excellent in the optical isotropy and the thickness uniformity than the melt extrusion method. Further, in the solution casting method, the produced film contains foreign materials less than in the melt extrusion method. Therefore, the solution casting method is applied to the film production method, especially that for producing the optical functional film.

It is known that the viscoelasticity causes the neck-in phenomena in which, when the casting dope is discharged from the casting die, the width of the casting bead of the discharged casting dope becomes smaller than that of an outlet of the casting die. If the neck-in phenomena occurs, the thickness of the casting bead becomes smaller in a central area and larger in side portions (hereinafter which are at most 1% apart from both side edges of the casting bead. The occurrence of the neck-in phenomena has a relation with the physical properties of the polymer, and processing conditions (length of the casting bead, a slit width of the casting die and the like). For example, if the elastic characteristics of the polymer become smaller, or if a stretching tension for the casting bead, the bead length, and the slit length of the casting die becomes larger, the neck-in phenomena often happens. If the neck-in phenomena cause the side portions to be extremely thick, the peeling trouble, such as the tear at the peeling and the like, occurs. Therefore, in order to prevent the peeling trouble, it is necessary to adjust the thickness of the side portions of the casting bead.

The method of adjusting the thickness of the side portions of the casting bead is disclosed in the Japanese Patent Laid-Open Publications No. 2005-007808, 2001-79924, 2005-279956, and the U.S. Pat. No. 5,451,357. In the publication No. 2005-007808, a deckle is used for regulating the width of the dope passage provided in the casting die, in a way that the width of the dope passage may be larger in the side of the outlet of the casting die. In the publication No. 2001-79924 & the U.S. Pat. No. 5,451,357, the inner deckle is slidable in the widthwise direction, so as to adjust the width of the dope passage. In the publication No. 2005-279956, the dope flowing in the casting die is separated into a central flow (or main flow) for forming a central portion of the casting bead and side flows (substantial flows) for forming side portions of the casting bead, and the flow volume of the side flows are adjusted.

In recent years, the high productivity is required for a solution casting method because of the rapid increase of the demand for a liquid crystal display. Further, the liquid crystal display becomes thinner and has a smaller weight. Therefore, the development of the solution casting method and the solution casting apparatus is made such that a thin optical function film may be produced effectively.

In order to increase the productivity of the solution casting method, the film production speed is sometimes made larger. The film production speed is depending on the casting speed of the casting process, as already known. Therefore, it is tried to increase the running speed of a support in the casting process (for example, to be more than 40 m/min), in order to increase the casting speed and the productivity. However, in accordance with the increase of the running speed of the support, the adhesivity of the casting film to the support surface becomes worse. If the adhesivity becomes worse, the entrained air occurring in accordance with the running of the support surface enters into a space between the casting film and the support, which causes the surface defect such as the nonsmoothness of the casting film. Therefore, in order to compensate for the decrease of the adhesion, it is necessary to make the decompression in a rear surface side (the upstream side) from the casting bead in the running direction of the support.

However, when the solution casting method is performed with the decompression of the rear surface side, the casting bead vibrates to be unstable, which causes the thickness unevenness of the casting film. As a result, the produced film has the thickness unevenness. Further, the side portions of the casting bead vibrate more easily than the central portion between both side portions. Therefore, in case that it is designate to produce the thinner film (for example, 60 μm in thickness) than the prior one, the bead thickness becomes thinner. Thus the casting bead becomes more unstable, and the produced film has the thickness unevenness more easily.

Therefore, it is necessary to adjust not only the thickness of the central portion of the casting bead but also the thickness of the side portions, when it is designate to produce the film efficiently.

In the method disclosed in the publication No. 2005-007808, the deckles provided in the casting die have to be changed or adjusted, and therefore it takes long time to make the thickness of the side portions to an adequate value. Therefore, the time for adjusting the thickness of the side portions is necessary each time at the change of the dope composition and the film production conditions, and thus the productivity becomes lower, and the method is not adequate for the producing a lot of types of the film.

In the method disclosed in the publication No. 2001-79924 & the U.S. Pat. No. 5,451,357, there is a slight space between the dope passage in the casting die and the deckle. The space forms a streak on the dope which has passes through the dope passage having the space, since the viscosity of the dope to be used in the solution casting method is lower than the molten polymer, and therefore the film surface of the produced film has a streak. Further, the dope sometimes retains in the space, which causes the gelation of the dope in the dope passage. If the gel-like material is mixed in the film, the thickness unevenness occurs and the optical properties of the film become worse.

Additionally, in order to perform the casting process stably, it is necessary to form the dope passage and the deckles in the casting die from a material (stainless and the like) which never deform in effect of the pressure of the dope. In the method of the publication No. 2001-79924 & the U.S. Pat. No. 5,451,357, the deckle is slid on a component disposed around the deckle, and dusts are generated by the sliding. If the dusts are mixed in the dope, the excellent film is hardly produced. So, in order to prevent the occurrence of the dusts, the deckle formed of a resin is used. However, in this case, the deckle is easily deformed in effect of the pressure of the casting dope, and therefore it is extremely hard to adjust the thickness of the side portions adequately.

Further, in the method disclosed in the publication No. 2005-279956, the pressures of the main flow and the substantial flows cannot be adjusted independently. Therefore it is hard to adjust only the thickness of the side portions to the predetermined value, in accordance to the production conditions of the film.

### SUMMARY OF THE INVENTION

An object of the present invention is to provide a casting die for producing an optical function film effectively with providing the thickness unevenness and a peeling trouble.

Another object of the present invention is to provide a dope discharging method and a solution casting method for producing an optical function film effectively with providing the thickness unevenness and a peeling trouble.

In a dope casting method of the present invention, in a dope casting method for forming on a moving support a casting film which is to be dried to a polymer film, a side dope for composing a side portion of a bead from a casting die to the support is prepared, the casting die discharges the side dope through a slit extending in a widthwise direction of the support, and a middle dope for composing a middle portion between the side portion of the bead is prepared. Then flows of the side dopes and the middle dope are joined in the casting die, and the casting die has a partitioning member with cut out such that the partitioning member may form a side flow passage for flowing the side dope and a middle flow passage for flowing the middle dope. A downstream end of the partitioning member is disposed in an upstream from the slit such that the side dopes and the middle dope may join before the flowing out from the slit. Then a co-application of the side dopes and the middle dope is made.

Preferably, a distance from the outlet to the downstream end is in the range of 01.1 mm to 40 mm. Further, a width W1 of the side flow passage in a lengthwise direction of the slit is at least 0.1 mm.

Preferably the side dope is supplied to the side feed passage by a side feeding device for feeding the side dope. Particularly preferably, the middle dope is supplied to the middle feed passage by a middle feeding device for feeding the middle dope, and a flow volume is independently controlled between the side dope flowing in the side flow passage and the middle dope flowing in the middle flow passage with use of the side feeding device and the middle feeding device.

Preferably, the middle dope, a first side dope to be supplied to one of the side flow passages, and a second side dope to be supplied to another one of the side flow passage are the same.

Preferably, elongation viscosity of the side dope is higher than that of the middle dope. Particularly, if the elongational viscosity of the side dope is ηe and the elongational viscosity of the middle dope is ηc, a value of ηe/ηc is at most 3. Furthermore, particularly, each solvent of the middle dope and the side dope contains a good solvent component and a poor solvent component, and a content of the poor solvent component to the solvent in the side dope is higher that a content of the poor solvent component to the solvent in the middle dope. Especially, a content of the polymer in the side dope is lower than a content of the polymer in the middle dope.

Preferably, the partitioning portion has at least a contact face for contacting one of the middle dope and a side dope, and the contact face is coated with a high molecular compound.

In a solution casting method of applying a dope on a moving support so as to produce a polymer film, a side dope for composing a side portion of a bead from a casting die to the support is prepared, the casting die discharges the side dope through a slit extending in a widthwise direction of the support, and a middle dope for composing a middle portion between the side portion of the bead is prepared. Then flows of the side dopes and the middle dope are joined in the casting die, and the casting die has a partitioning member with cut out such that the partitioning member may form a side flow passage for flowing the side dope and a middle flow passage for flowing the middle dope. A downstream end of the partitioning member is disposed in an upstream from the slit such that the side dopes and the middle dope may join before the flowing out from the slit. Then a co-application of the side dopes and the middle dope is made. After the casting film has self-supporting properties, the casting film is peeled as the polymer film from the support, and the polymer film is dried.

In the present invention, a casting unit for applying a dope with forming a bead on a moving support includes a casting die for discharging the dope, and the casting die is provided with a side inlet for supplying a side dope to compose a side portion of the bead, a middle inlet for supplying a middle dope to compose a middle portion between the side portions, a slot for forming the side dope and the middle dope, a slit for making a co-discharging of the side dope and the middle dope, and a manifold for retaining the middle dope. Further, the casting unit includes a partitioning portion disposed in the slot, the partitioning portion partitions the slot into a side flow passage for flowing the side dope and a middle flow passage for flowing the middle dope, a downstream end of the partitioning portion has a cutoff with acute angle, the cut off is disposed in the range of 0.1 mm to 40 mm in an upstream side from the slit. Furthermore the casting unit includes a feeding device for feeding the side dope to the side inlet.

Preferably the side dope is supplied to the side feed passage by a side feeding device for feeding the side dope. Particularly preferably, the middle dope is supplied to the middle feed passage by a middle feeding device for feeding the middle dope, and a flow volume is independently controlled between the side dope flowing in the side flow passage and the middle dope flowing in the middle flow passage with use of the side feeding device and the middle feeding device.

Preferably, the partitioning portion has at least a contact face for contacting one of the middle dope and a side dope, and the contact face is coated with a high molecular compound.

According to the present invention, the slot in the casting die is provided with two partitioning portions for partitioning the slot into the slot middle portion and the slot side portions, and the first casting dope is fed into the slot middle portion and the second and third casting dopes are fed into the slot side portions. Then the first-third casting dopes are joined and thereafter fed to the outlet of the casting die, so as to form the casting bead between the outlet and the support. Further, flow volumes of the second and third casting dopes are independently controlled, the thickness of the side portions of the casting bead is easily adjusted to the predetermined values. Thus the peeling trouble and the thickness unevenness are reduced such that the optical function film may be produced efficiently.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a dope production line for producing a primary dope;

FIG. 2 is a flow chart of a film production from the primary dope;

FIG. 3 is a schematic diagram of a film production line for producing a film from the primary dope;

FIG. 4 is a sectional view of a first embodiment of a casting die in the film production line;

FIG. 5 is a sectional view of the casting die along a line V-V in FIG. 4;

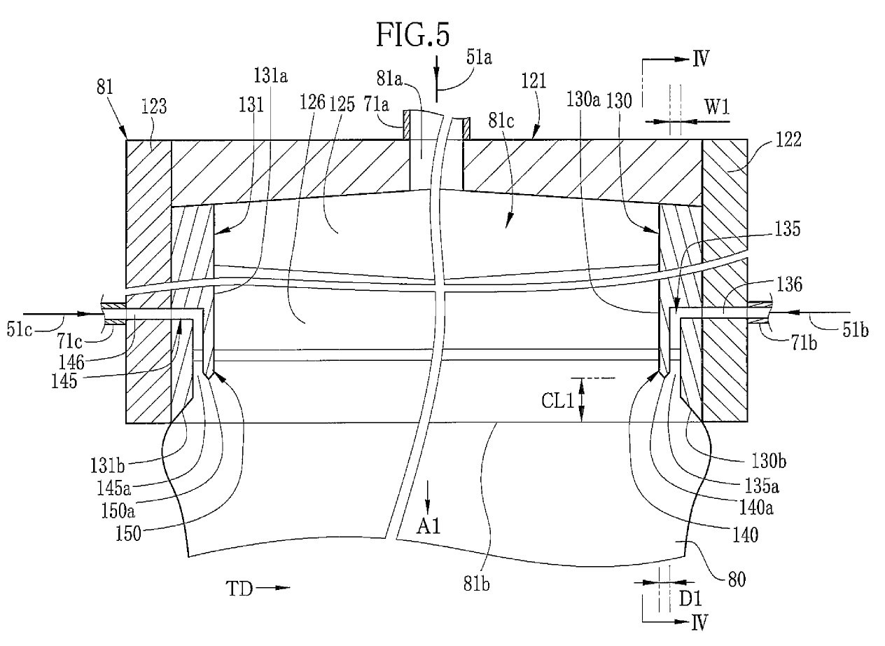

FIG. 6 is a sectional view of a second embodiment of a casting die in the film production line;

FIG. 7 is a sectional view of a third embodiment of a casting die in the film production line; and

FIG. 8 is a sectional view of a fourth embodiment of a casting die in the film production line.

### PREFERRED EMBODIMENTS OF THE INVENTION

In followings, the preferred embodiments will be explained in detail. However, the present invention is not restricted in the description.

[Raw Material]

(Polymer)

As polymer of this embodiment, the already known polymer to be used for the solution casting method may be used. For example, cellulose acylate is preferable, and triacetyl cellulose (TAC) is especially preferable. It is preferable in cellulose acylate that the degree of substitution of acyl groups for hydrogen atoms on hydroxyl groups of cellulose preferably satisfies all of following formulae (I)-(III). In these formulae (I) — (III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 wt. % of TAC is particles having diameters from 0.1 mm to 4 mm.

2.5≦A+B≦3.0 (I)

0≦A≦3.0 (II)

0≦B≦2.9 (III)

Further, polymer to be used in the present invention is not restricted in cellulose acylate.

A glucose unit constructing cellulose with β-1,4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 1.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particularly 2.22 to 2.90, and especially 2.40 to 2.88. Further, DS6/(DS2+DS3+DS6) is preferably at least 0.28, particularly at least 0.30, and especially 0.31 to 0.34.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88. Further, DSB is preferably at least 0.30, and especially at least 0.7. According to DSB, the percentage of the substitution on the 6^{th} position to that on the 2^{nd}, 3^{rd} and 6^{th} positions is at least 20%. The percentage is preferably at least 25%, particularly at least 30%, and especially at least 33%. Further, DSA+DSB of the 6^{th} position of the cellulose acylate is preferably at least 0.75, particularly at least 0.80, and especially at least 0.85. When these sorts of cellulose acylate are used, a solution (or dope) having preferable solubility can be produced, and especially, the solution having preferable solubility to the non-chlorine type organic solvent can be produced. Further, when the above cellulose acylate is used, the produced solution has low viscosity and good filterability. Note that the dope contains a polymer and a solvent for dissolving the polymer. Further, if necessary, an additive is added to the dope.

The cellulose as the raw material of the cellulose acylate may be obtained from one of the pulp and the linter.

In cellulose acylate, the acyl group having at least 2 carbon atoms may be aliphatic group or aryl group. Such cellulose acylate is, for example, alkylcarbonyl ester and alkenylcarbonyl ester of cellulose. Further, there are aromatic carbonyl ester, aromatic alkyl carbonyl ester, or the like, and these compounds may have substituents. As preferable examples of the compounds, there are propionyl group, butanoyl group, pentanoyl group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinnamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinnamoyl group and the like, and the especially preferable groups are propionyl group and butanoyl group.

(Solvent for Dope)

Further, as solvents for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like. Note that the dope is a polymer solution or dispersion in which a polymer and the like is dissolved to or dispersed in the solvent. It is to be noted in the present invention that the dope is a polymer solution or a dispersion that is obtained by dissolving or dispersing the polymer in the solvent.

The solvents are preferably hydrocarbon halides having 1 to 7 carbon atoms, and especially dichloromethane. Then in view of the dissolubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 wt. % to 25 wt. %, and particularly in the range of 5 wt. % to 20 wt. %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 carbons, and alcohols having 1 to 12 carbons are preferable, and a mixture thereof can be used adequately. For example, there is a mixture of methyl acetate, acetone, ethanol and n-butanol. These ethers, ketones, esters and alcohols may have the ring structure. Further, the compounds having at least two of functional groups in ethers, ketones, esters and alcohols (namely, —O—, —CO—, —COO— and —OH) can be used for the solvent.

Note that the detailed explanation of cellulose acylate is made from [0140] to [0195] in Japanese Patent Laid-Open Publication No. 2005-104148, and the description of this publication can be applied to the present invention. Note that the detailed explanation of the solvents and the additive materials of the additive (such as plasticizers, deterioration inhibitors, UV-absorptive agents, optical anisotropy controllers, dynes, matting agent, release agent, retardation controller and the like) is made from [0196] to [0516] in Japanese Patent Laid-Open Publication No. 2005-104148.

[Dope Production Method]

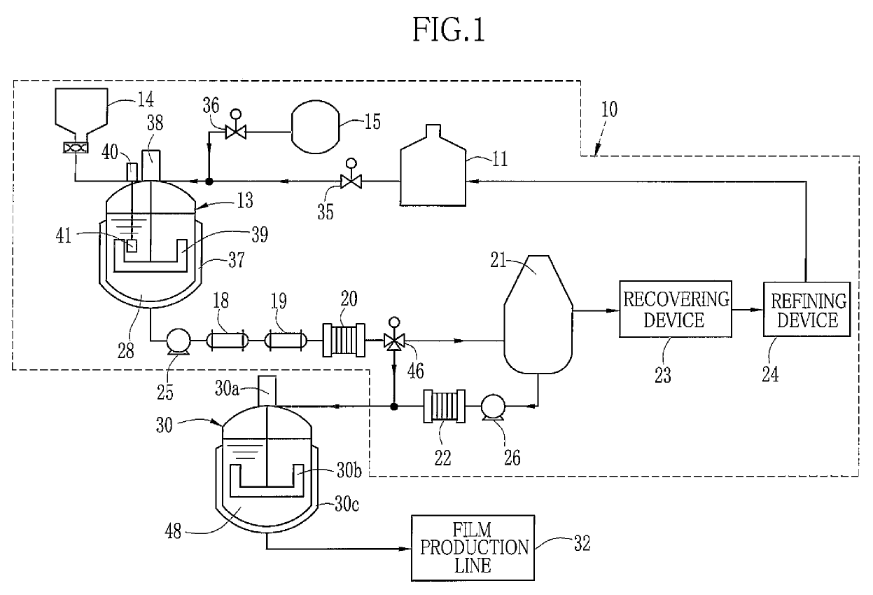

The dope is produced from the above raw materials. As shown in FIG. 1, a dope production line 10 is constructed of a solvent tank 11 for storing a solvent, a mixing tank 13 for mixing the TAC and the solvent therein, a hopper 14 for supplying the TAC and an additive tank 15 for storing an additive. Further, in the dope production line 10, there is a heating device 18 for heating a swelling liquid (described below in detail), a temperature controller 19 for controlling the temperature of a prepared dope, and a filtration device 20. Further, the dope production line 10 is provided with a flushing device 21 for concentrating the dope and a filtration device 22. Furthermore, the dope production line 10 has a recovering device 23 for recovering a solvent vapor, and a refining device 24 for recycling the recovered solvent. The dope production line 10 is connected to a film production line 32.

In the dope production line 10, a primary dope 48 is produced in the following order. A valve 35 which is disposed on a pipe connecting the solvent tank 11 to the mixing tank 13 is opened such that the solvent in the solvent tank 11 may be fed to the mixing tank 13.

Then the TAC in the hopper 14 is fed to the mixing tank 12 with measuring the amount thereof. Thereafter, a valve 36 is opened and closed such that a necessary amount of the additive may be sent from the additive tank 15 to the mixing tank 13. The method of feeding the additive to the mixing tank is not restricted in the above description. In case that the additive is in the liquid state in the room temperature, it may be fed in the liquid state to the mixing tank 13 without preparing for the additive solution. In case that plural sorts of additive compounds are used, the additive containing the plural additive compounds may be accumulated in the additive tank 15 altogether. Otherwise plural additive tanks may be used so as to contain the respective additive compounds, which are sent through independent pipes to the mixing tank 13.

In the above explanation, the solvent, the TAC, and the additive are sequentially sent to the mixing tank 13. However, the sending order is not restricted in it. For example, after the predetermined amount of the TAC is sent to the mixing tank 13, the feeding of the predetermined amount of the solvent and the additive may be performed to obtain a TAC solution. Otherwise, it is not necessary to feed the additive to the mixing tank 13 previously, and the additive may be added to a mixture of TAC and solvent in following processes.

The mixing tank 13 is provided with a jacket 37 covering over an outer surface of the mixing tank 13, a first stirrer 39 to be rotated by a motor 38, and a second stirrer 41 to be rotated by a motor 40. The mixing tank 13 stores a dissolution liquid 28 obtained by mixing the solvent, the TAC and the additive. Further, the first stirrer 39 preferably has an anchor blade, and the second stirrer 41 is preferably an eccentric stirrer of a dissolver type. Note that the dissolution liquid 28 may be a swelling liquid in which the TAC may be swollen in the solvent.

The inner temperature in the mixing tank 13 is controlled by a heat transfer medium in the jacket 37. The preferable inner temperature is in the range of −10° C. to 55° C. Note that the selection of the first stirrer 39 and the second stirrer 41 is made in accordance with the conditions of the dope preparation.

A pump 25 is driven such that the dissolution liquid 28 in the mixing tank 13 may be sent to the heating device 18 which is preferably a pipe with a jacket. The heating device 18 may be preferably provided with a pressuring device so as to progress the dissolution effectively. When the heating device 18 is used, the dissolution of solid compounds proceeds under the heating or the heat-pressurizing conditions such that a dope may be obtained. This method is called a heat-dissolution method. The temperature of the dissolution liquid 28 is preferably in the range of 0° C. to 97° C. In order to dissolve the TAC to the solvent sufficiently, it is preferable to perform not only the heat-dissolution method but also a cool-dissolution method. The heated dissolution liquid 28 is sent to the temperature controller 19 to control the temperature of the dissolution liquid 28 nearly to a room temperature. Then the filtration of the dope is made in the filtration device 20, such that impurities and undissolved materials may be removed from the dope. The filter material of the filtration device 20 preferably has an averaged nominal diameter of at most 100 μm. The flow volume of the filtration in the filtration device 20 is preferably at least 50 liter/hr. The dope after the filtration is fed through a valve 46 and thus stored as the primary dope 48 in a stock tank 30.

The dope can be used as the primary dope 48 for a film production, which will be explained. However, in the method in which the dissolution of TAC is performed after the preparation of the dissolution liquid 28, if it is designated that a dope of high concentration is produced, the time for production of such dope becomes longer. Consequently, the production cost becomes higher. Therefore, it is preferable that a dope of the lower concentration than the predetermined value is prepared at first and then the concentrating of the dope is made. In this embodiment, the dope after the filtration is sent to the flushing device 21 through the valve 46. In the flushing device 21, the solvent of the dope is partially evaporated. The solvent vapor generated in the evaporation is condensed by a condenser (not shown) to a liquid state, and recovered by the recovering device 23. The recovered solvent is recycled by the refining device 24 and reused. According to this method, the decrease of cost can be designated, since the production efficiency becomes higher and the solvent is reused.

The dope after the concentrating as the above description is taken from the flushing device 21 through a pump 26. Further, in order to remove bubbles generated in the dope, it is preferable to perform the bubble removing treatment. As a method for removing the bubble, there are many methods which are already known, for example, an ultrasonic irradiation method and the like. Then the dope is fed to the filtration device 20, in which the undissolved materials are removed. Note that the temperature of the dope in the filtration device 20 is preferably in the range of 0° C. to 200° C.

The dope after the filtration is stored as the primary dope 48 in the stock tank 30, which is provided with a stirrer 30b rotated by a motor 30a. Thus the produced dope preferably has the TAC concentration in the range of 5 wt. % to 40 wt. %.

Note that the method of producing the primary dope 48 is disclosed in detail in [0517] to [0616] in Japanese Patent Laid-Open Publication No. 2005-104148, for example, about the dissolution method and the adding methods of the materials, the raw materials and the additives in the solution casting method for forming the TAC film, the filtering method, the bubble removing method, and the like. The description is also applied to the present invention.

[Film Production Process]

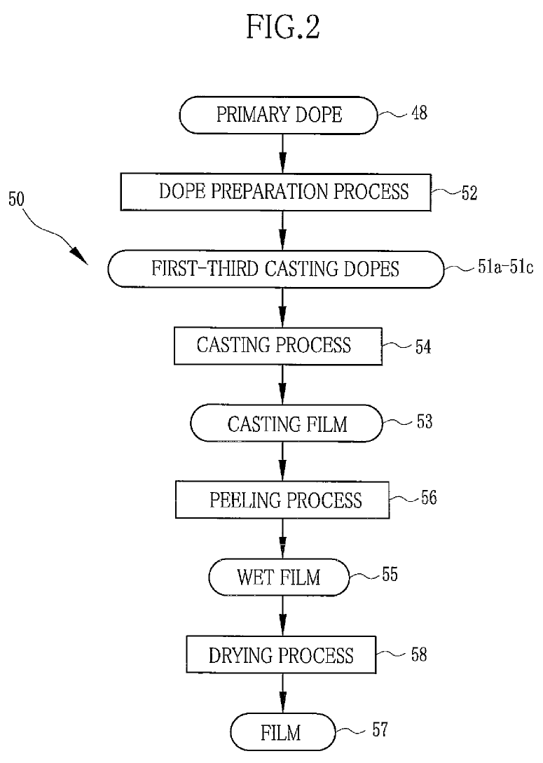

The film production process will be explained. As shown in FIG. 2, a film production process 50 includes a casting dope preparation process 52, a casing process 54, a peeling process 56, and a drying process 58. In the casting dope preparation process 52, first-third casting dopes 51a-51c are prepared from the primary dope 48 which is obtained in the dope production line of FIG. 1. In the casting process 54, the casting of the first-third casting dopes 51a-51c is made such that a casting film 53 may be obtained. In the peeling process 56, the casting film 53 is peeled as a wet film 55. In the drying process 58, the wet film 55 is dried to be a film 57. Note that the film production process 50 further has a winding process in which the film 57 is wound up to a film roll.

[Solution Casting Method]

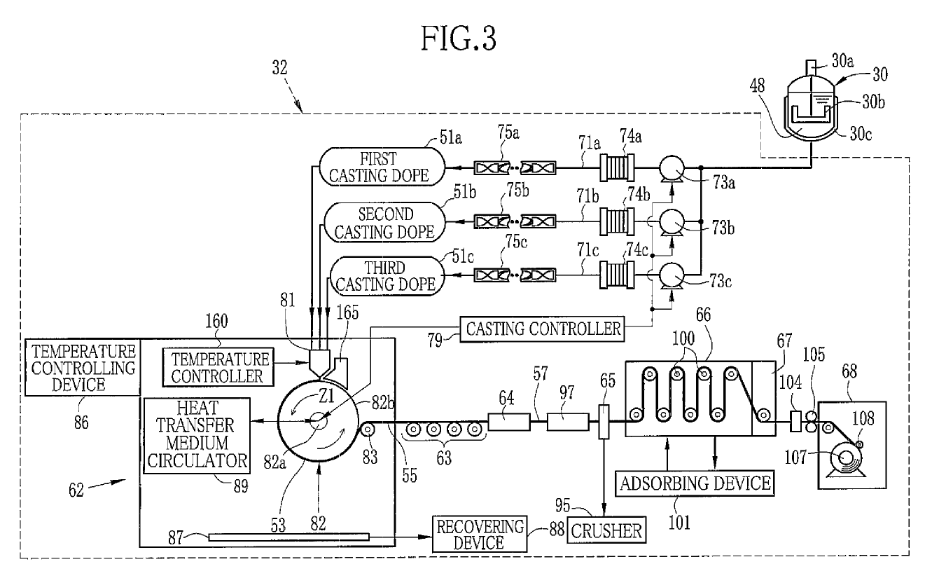

An embodiment of the solution casting method will be described in reference with FIG. 3, now. However, the present invention is not restricted in the embodiment. As shown in FIG. 3, the film production line 32 includes a casting chamber 62, a path roller 63, a pin tenter 64, an edge slitting device 65, a drying chamber 66, a cooling chamber 67, and a winding chamber 68.

The stock tank 30 is provided with a motor 30a, a stirrer 30b to be rotated with the motor 30a, and a jacket 30c. The stock tank 30 stores the primary dope 48, the stirrer 30b is rotated, and the inner temperature of the stock tank 30 is controlled by supplying a temperature controlling medium (not shown) into the jacket 30c. Thus the aggregation of the polymer and the like is reduced such that the primary dope 48 may be uniform in the stock tank 30.

The stock tank 30 is connected to the casting chamber 62 through pipes 71a-71c. On the pipe 71a, there are a gear pump 73a, a filtration device 74a and a static mixer 75a as an inline mixer. On the pipe 71b, there are a gear pump 73b, a filtration device 74b and a static mixer 75b as an inline mixer. On the pipe 71c, there are a gear pump 73c, a filtration device 74c and a static mixer 75c as an inline mixer.

In the upstream side from the static mixers 75a-75c, an additive supplying line is connected to the pipes 71a-71c for feeding an additive compound (at least one of the predetermined amount of UV absorbing agent, matting agent and retardation agent and the like) or a polymer solution containing the additive compound. Note that the additive compound and the polymer solution containing the additive compound are hereinafter called a mixture additive.

The gear pumps 73a-73c are connected to a casting controller 79. Thus the casting controller 79 controls the drive of the gear pumps 73a-73c so as to feed the primary dope 48 at a predetermined flow volume from the stock tank 30 to a casting die 81 provided in the casting chamber 62. Then the additive compounds or the polymer solution is added to the primary dope 48 fed through the pipes 71a-71c. Thereafter, in the respective pipes 71a-71c, the mixing of the primary dope 48 is made by the static mixers 75a-75c, such that the first-third casting dopes 51a-51c may be obtained.

The casting chamber 62 includes the casting die 81, a casting drum 82 to be rotated in a rotary direction Z1, a peel roller 83, a temperature controlling device 86, a condenser 87, a recovering device 88, a decompression chamber 165. In the casting chamber 62, the first-third casting dopes 51a-51c are cast by the casting die 81 onto the casting drum 82 so as to form a casting bead 80 between the casting die 81 and the casting drum 82. Thereafter the casting film 53 is peeled as the wet film 55 with support of the peel roller 83. The inner temperature of the casting chamber 62 is controlled by the temperature controlling device 86, and the solvent vapor generated by the evaporation of the solvent in the casting chamber 62 is condensed by the condenser 87, and thereafter recovered by the recovering device 88. Then the recovered solvent is reused for the dope preparation. Thus the recovering device 88 controls the vapor pressure of the solvent in the atmosphere in the casting chamber 62 to a predetermined range.

<Casting Drum>

The casting drum 82 is disposed below the casting die 81, and has a drum or cylindrical form. The casting drum 82 has a shaft 82a which is connected to the casting controller 79. Thus the casting controller 79 also controls the rotation speed of the casting drum 82 in a rotary direction Z1, such that a speed of a periphery 82b of the casting drum 82 to the casting die 81 may be a predetermined value.

In order to control the surface temperature of the casting drum 82 to a predetermined value, it is preferable to provide a heat transfer medium circulator 89. The heat transfer mediums whose temperatures are controlled by the heat transfer medium circulator 89 pass through paths (not shown). Thus the temperature T1 of the periphery 82b of the casting drum 82 is kept to the predetermined values.

The width of the casting drum 82 is not restricted especially. However, the width of the casting drum 82 is preferably 1.1 to 2.0 times as large as the casting width. The periphery is preferably grind such that surface roughness of the periphery 82b is preferably at most 0.01 μm. Further, it is preferable that the surface defect on the periphery 82b must be reduced to be minimal. Concretely there are no pin hole of at least 30 μm, at most one pin hole at least 10 μm and less than 30 μm, and at most two pin holes of less than 10 μm per 1 m². The rotation speed of the casting drum 82 fluctuates at most 3% to a predetermine value, and when the casting drum 82 rotates once, the meandering in the widthwise direction is at most 3 mm.

The material of the casting drum 82 is preferably stainless, and especially SUS 316 such that the casting drum 82 may have the enough resistance to corrosion and the strength. On the periphery 82b, it is preferable to make the chrome coating. Thus the periphery 82b has the enough resistance to corrosion and the strength.

(Peel Roller)

The peel roller is disposed in the downstream side from the casting die 81 in the rotary direction Z1 so as to be close to the periphery 82b. When the casting film 53 is peeled as the wet film 55 from the casting drum 82, the peel roller 83 supports the wet film 55 and guide the wet film 5 to the path roller 63.

The temperature controlling device 86 is used for keeping the inner temperature of the casting chamber 62 in a predetermined range. In the casting chamber 62, the solvent vapor is generated by the evaporating of the solvent from the discharged first-third casting dopes 51a-51c, the casting film 53, the wet film 55 and the like. The solvent vapor is condensed by the condenser 87, and then recovered by the recovering device 88. The recovered solvent is recycled as the solvent for the dope preparation. Thus in the casting chamber 62, the vapor pressure of the solvent vapor is kept to a predetermined value.

In a downstream from the casting chamber 62 are disposed a plurality of path rollers 63, the pin tenter 64, and the edge slitting device 65.

The path rollers 63 support and guide the wet film 55 to the pin tenter 64, after the wet film 55 is fed out from the casting chamber 62. Note that there is an air feeder (not shown) near the path rollers 63. Thus the air feeder feeds out a drying air to the wet film 55 on the path rollers 63 or to part of the wet film 55 between path rollers on a feed path, so as to dry the wet film 55.

The pin tenter 64 includes a plurality of pins (not shown) as a holding member for holding the wet film 55. The pins are attached to a circular chain, and endlessly move in accordance with the running of the chain. In the pin tenter 64, many pins are inserted into both side edge portions near an entrance. Thus both side edge portions are held by the pins, and transported. In the pin tenter 64, there is an air blower (not shown) for feeding a drying air to the wet film 55. Thus the content of remaining solvent in the wet film 55 is decreased while wet film 55 is transported in the pin tenter 64. Near the exit of the pin tenter 64, the pins are removed from both side edge portions of the film 57.

The film 57 is fed to the edge slitting device 65, and both side edge portions are slit off. The edge slitting device 65 is connected with a crusher 95, and the both side edge portions are crushed by the crusher 95 so as to be tips. The tips contain the TAC and several sorts of the additive compounds. Therefore the tips are dissolved to the solvent, and then the additives are removed. Thus only the TAC is obtained, and then reused.

Note that there may be a clip tenter 97 for drying the film 57 between the pin tenter 64 and the edge slitting device 65. The clip tenter 97 is a drying device which includes a plurality of clips as clipping member of both side edge portions of the film 57. The clip tenter 97 stretches the film 57 under a predetermined condition, so as to provide a predetermined optical property for the film 57.

In the drying chamber 66, there are many rollers 100 and an adsorbing device 101. The film 57 is transported into a cooling chamber 67, and cooled down. In the downstream side from the cooling chamber, there is a compulsory neutralization device (or a neutralization bar) 104 for eliminating the charged electrostatic potential of the film 57 to the predetermined value. Further, in this embodiment, there is a knurling roller 105 for providing a knurling to the film 57 in the downstream side of the compulsory neutralization device 104.

The inner temperature of the drying chamber 66 is not restricted especially. However, it is preferable in the range of 50° C. to 160° C. In the drying chamber 66, the film 57 is transported with lapping on many rollers 100. The solvent vapor evaporated from the film 57 by the drying chamber 66 is adsorbed by the adsorbing device 101. The air from which the solvent components are removed is reused for the drying air in the drying chamber 66. Note that the drying chamber 66 preferably has plural partitions for variation of the drying temperature. Further, a pre-drying device (not shown) is provided between the edge slitting device 65 and the drying chamber 66, so as to perform the pre-drying of the film 57. Thus it is prevented that the temperature of the film 57 increases rapidly, and therefore the change of the shape of the film 57 is reduced.

The film 57 is transported toward the cooling chamber 67, and cooled therein to around the room temperature. A humidity control chamber (not shown) may be provided for conditioning the humidity between the drying chamber 66 and the cooling chamber 67. Preferably, in the humidity control chamber, an air whose temperature and humidity are controlled is applied to the film 57. Thus the curling of the film 57 and the winding defect in the winding process can be reduced.

Thereafter, the compulsory neutralization device (or neutralization bar) 104 eliminates the charged electrostatic potential of the film 57 to the predetermined value (for example, in the range of −3 kV to +3 kV). After the neutralization, the embossing of both side portions of the film 57 is made by the embossing rollers to provide the knurling. The emboss height from the bottom to the top of the embossment is in the range of 1 μm to 200 μm.

In the winding chamber 68, there are a winding shaft 107 and a press roller 108. Thus the film 57 is wound by the winding shaft 107 in the winding chamber 68. At this moment, a tension is applied at the predetermined value to the press roller 108.

(Casting Die)

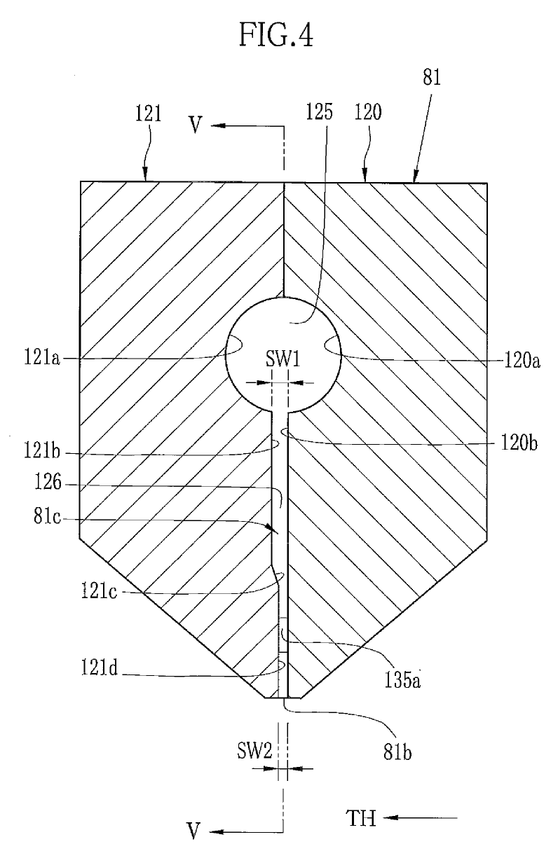

As shown in FIGS. 4 & 5, the casting die 81 is constructed of lip plates 120, 121, and side plates 122, 123, and has an inlet 81a through which the first casting dope 51a flows from the pipe 71a, and an outlet 81 through which the first-third casting dopes 51a-51c are discharged for the casting. The first-third casting dopes 51a-51c are fed through the respective inlets and joined in the casting die 81.

The lip plate 120 has contact faces 120a, 120b for contacting the first-third casting dopes 51a-51c from the inlet 81a to the outlet 81b. The lip plate 121 has contact faces 121a-121d for contacting the first-third casting dopes 51a-51c from the inlet 81a to the outlet 81b. The contact faces 120a, 120b, 121a-121d are combined to form a dope passage 81c connecting the inlet 81a to the outlet 81b throughout. On the dope passage 81c, there are a manifold 125 and a slit 126. The manifold 125 is formed by the contact faces 120a, 121a which are arranged in a direction TD as a widthwise direction of the casting die 81 (or a lengthwise direction of the slit 126). The slit 126 is area between the contact face 120b and the contact surfaces 121b-121d. Note that the lip plates 120, 121 are extended in the direction TD, and the lip plate 120 is disposed in an upstream side from the lip plate 121 in a rotary direction of the casting drum 82.

The slit 126 in the upper area has a slit width SW1 between the contact faces 120b and 121b, and the slit 126 in the lower area has a slit width SW2 between the contact faces 120b and 121d. Note that the upper area is an area in an upstream side of the casting dope 51a in the flowing direction, and the lower area is an area in a downstream side of the casting dope 51a in the flowing direction. The slit width SW2 is smaller than the slit width SW1. Further, the middle area of the slit 126 is between the upper area of the slit width SW1 and the lower area of the slit width SW2, and is constructed of the contact faces 120b and 121c. In the middle area, the contact face 121c connects the contact face 121b to the contact face 121d, and is inclined to the contact faces 121b and 121d, such that the slit width may become smaller at a position closer to the lower area, and thus the slit width may be continuously decreased from SW1 to SW2.

The inner deckle plates 130, 131 are disposed in both side edges of the dope passage 81c in the direction TD. The inner deckle plates 130, 131 are adhered to the lip plates 120, 121 and the side plates 122, 123 by their packing (not shown). Thus the inner deckle plates 130, 131 are extended in a direction TH as a widthwise direction of the manifold 125 and the slit 126, and the inner deckle plate 130 is disposed in an upstream side from the inner deckle plate 121 in a rotary direction of the casting drum 82.

The inner deckle plate 130 has a contact faces 130a, 130b contacting to the first-third dopes 51a-51c. The inner deckle plate 131 has contact faces 131a, 131b contacting to the first-third dopes 51a-51c. The contact faces 130a, 131a are formed such that the width of the dope passage 81c may be almost constant. The contact faces 130b, 131b are inclined to the contact faces 130a, 131a, such that the width of the dope passage 81c may be larger.

In the casting die 81, there are passages 135, 136 formed through the inner deckle plate 130 and the side plate 122. The passage 136 connects the pipe 71b with the passage 135. The passage 135 extends downwardly so as to have a size or width W1 in the direction TD, and connects the passage 136 with the slit 126. An outlet 135a of the passage 135 is formed on the contact face 130b of the inner deckle plate 130. The inner deckle plate 130 has a partitioning portion 140 for partitioning the passage 135 and the passage 81c. The partitioning portion 140 has an acute angle end 140a in a side of the outlet 81b. A vertex of the end 140a is disposed near the center in the direction TD. Further, the end 140a is formed so as to have a clearance CL1 to the outlet 81b.

In the casting die 81, there are passages 145, 146 formed through the inner deckle plate 131 and the side plate 123. The passage 146 connects the pipe 71c with the passage 145. The passage 145 extends downwardly, and connects the passage 146 with the slit 126. An outlet 145a of the passage 145 is formed on the contact face 131b of the inner deckle plate 131. The inner deckle plate 131 has a partitioning portion 150 for partitioning the passage 145 and the passage 81c. The partitioning portion 150 has an acute angle end 150a in a side of the outlet 81b. A vertex of the end 150a is disposed near the center in the direction TD. Further, the end 150a is formed so as to have a clearance CL1 to the outlet 81b.

The thickness D1 of each partitioning portion 140, 150 in the direction TD is preferably at most 2 mm. If the thickness is more than 2 mm, it is sometimes hard to form the casting bead 80 stably. Further, a lower limit of the thickness D1 is not restricted especially, so far as the partitioning portions 140, 150 are not deformed or damaged in effect of the pressure from the first-third casting dopes 51a-51c.

(Material)

The materials to be used for producing the lip plates 120, 121 and the inner deckle plates 130, 131 in the casting die 81 preferably have resistance to the oxidization and the corrosion which the contact to the casting dope 51 causes. Further, in order to keep the distances CL1-CL4 in the predetermined range, it is preferable that the size variation hardly occurs in the casting process. Thus the materials for the lip plates 120, 121 and the inner deckle plates 130, 131 preferably have the following characteristics:

(1) the corrosion resistance is the same as SUS316 in the compulsory corrosion experiment in an electrolyte water solution,

(2) the pitting (or pitting corrosion) does not occur on the gas-liquid interface even if this material were dipped in a mixture liquid of dichloromethane, methanol and water for three months, and

(3) the coefficient of thermal expansion is at most 2×10⁻⁵ (° C.⁻¹).

Therefore, the materials for the lip plates 120, 121 and the inner deckle plates 130, 131 are preferably a stainless steel and a ceramics, particularly preferably a stainless steel of austenite type, and especially preferably SUS316, SUS316L, a stainless steel of precipitation hardening type, such as SUS630, SUS631 and the like

If the above adjusting method is made, it is preferable to further satisfy not only the above conditions (1)-(3) but also the following conditions:

(4) the rate of the volume change of the lip plates 120, 121 and the inner deckle plates 130, 131 during the forming processing is at most 0.05%, and

(5) the inner deckle plates 130, 131 is not so hard as to damage the lip plates 120, 121.

It is preferable in the present invention, the rate of volume change of the lip plates 120, 121 and the inner deckle plates 130, 131 satisfies the above condition (4). The rate of volume change means a maximum of the rates of the size change aₓ, a_{y}, a_{z}, in the x, y, z rectangular coordinate system. The rate of the size change aₓ is defined to Δbₓ/bₓ, in the case that the size change of the inner deckle plate 130, 131 is Δbₓ on the application of the outer force F (about 90 N) per unit size (1 mm²) in the x-axis direction and the size of the inner deckle plate before the application of the outer force is bₓ. The rate of the size change a_{y} is defined to Δb_{y}/b_{y}, if the size fluctuation of the inner deckle plate 130, 131 is Δb_{y} on the application of the outer force F in the y-axis direction and the size of the inner deckle plate before the application of the outer force is b_{y}. The rate of the size change a_{z} is defined to Δb_{z}/b_{z}, in the case that the size change of the inner deckle plate 130, 131 is Δb_{z} on the application of the outer force F in the z-axis direction and the size of the inner deckle plate before the application of the outer force is b_{z}.

According to the condition (5), for example, if the precipitation hardened stainless is used as the material for the lip plates 120, 121, it is preferable that the materials for the inner deckle plate 130, 131 has the Vickers hardness in the range of 200 Hv to 1000 Hv. Therefore, the stainless or the ceramics are preferably used as the materials for the inner deckle plate 130, 131. Further, the material for the inner deckle plate preferably has magnetism.

According to the contact faces 120a, 120b, 121a-121d, 130a, 130b, 131a, 131b of the lip plates 120, 121 and the inner deckle plates 130, 131, it is preferable that the finish accuracy is at most 1 μm in surface roughness and the straightness is at most 1 μm/m in any direction. When the finish accuracies of the contact faces 120a, 120b, 121a-121d, 130a, 130b, 131a, 131b satisfy the above condition, the formation of the streak and the unevenness on the casting film is prevented. The smoothness on the end of each inner deckle plate 130, 131 in the side of the outlet 81b is preferably at most 2 μm. An average value of each clearance SW1, SW2 of the slit 126 of the casting die 81 is automatically adjustable in the range of 0.5 mm to 3.5 mm. According to an edge of the contact portion of a lip end of the casting die 81 to the casting dope, R (R is chamfered radius) is at most 50 μm in all of a width.

Preferably, a hardened layer is preferably formed on the end of the lip plates 120, 121 and the inner deckle plates 130, 131 in the side of the outlet 81b. A method of forming the hardened layer is not restricted. But it is, for example, ceramics hard coating, hard chrome plating, nitriding processing, and the like. In case that ceramics is used as the hardened layer, it is preferable that the used ceramics is grindable but not friable, with a lower porosity, high resistance of corrosion, and no adhesiveness to the casting die 81. Concretely, there are tungsten carbide (WC), Al₂O₃, TiN, Cr₂O₃, and the like. Especially preferable ceramics is tungsten carbide. Tungsten carbide coating can be made by a spraying method.

A width of the casting die 81 is not restricted especially. However, the width is preferably at least 1.1 times and at most 2.0 times as large as a film width. Further, it is preferable to attach a temperature controller 160 to the casting die 81, such that the temperature may be kept to the predetermined one during the film production. In order to adjust a film thickness, the casting die 81 is preferably provided with an automatic thickness adjusting device. For example, thickness adjusting bolts (heat bolts) are disposed at a predetermined distance in the direction TD. Because of the heat bolts, the clearance SW1, SW2 of the slit 126 and the width W1 of the passages 135, 145 can be adjusted to the respectively predetermined values. According to the heat bolts, it is preferable that the profile is set on the basis of a predetermined program, depending on feed rate of the pumps (preferably, high accuracy gear pumps), while the film production is performed. Further, the feed back control of the adjustment value of the heat bolts may be made by the adjusting program on the base of the profile of a thickness meter (not shown), such as infrared ray thickness meter and the like. The thickness difference between any two points in the direction TD except the side edge portions in the casting film is controlled preferably to at most 1 μm. The difference between the maximum and the minimum of the thickness in the direction TD is at most 3 μm, and especially at most 2 μm. Further, the accuracy to the designated object value of the thickness is preferably in ±1.5 μm. Further, it is preferable to control the shearing rate of the casting dope 51 in the range of one (1/sec) to 5000 (1/sec).

(Decompression Chamber)

In order to form the dope bead 80 stably, the decompression chamber 90 (see, FIG. 3) aspirates the air in a upstream side of the rotary direction Z1, such that the pressure in the upstream side is lower in the range of 10 Pa to 2000 Pa than that in the downstream side. Further, the decompression chamber 90 is provided with a jacket (not shown), and thus the inner temperature of the decompression chamber 90 may be controlled to a predetermined value. The inner temperature is not restricted especially. However, it is preferable to be lower than the boiling point of the used solvent.

In followings, an example of the method of producing the film 57 will be explained in reference with FIG. 3. In the film production line 32, the primary dope 48 is made uniform by stirring the stirrer 30b. At the stirring, additives such as a plasticizer or the like can be added to the primary dope 48. Further, a heat transfer medium is fed into the jacket 30c, so as to keep the temperature of the primary dope 48 about a predetermined value in the range of 25° C. to 35° C.

The casting controller 79 drives the gear pumps 73a-73c to feed the primary dope 48 into the pipes 71a-71c through the filtration devices 74a-74c. In the filtration device 74, the filtration of the primary dope 48 is made. The additives containing a matting agent solution, a UV absorbing agent solution and the like are fed through the additive supplying line to the pipes 71a-71c. Then the primary dope 48 is stirred by the static mixers 75a-75c to be the casting dope 51. At the stirring by the static mixers 75a-75c, the temperature of the primary dope 48 is preferably kept to be a constant value in the range of 30° C. to 40° C. Then the casting dope is fed to the casting die 81 in the casting chamber 62 by the drive of the gear pumps 73a-73c.

The recovering device 88 keeps the vapor pressure of the solvent vapor in the atmosphere of the casting chamber 62 to about a predetermined value. The temperature controlling device 86 controls the temperature of the atmosphere in the casting chamber to be a constant value in the range of −10° C. to 57° C.

The casting die 81 is covered with a jacket (not shown) in which a heat transfer medium is supplied. The temperature of the heat transfer medium is controlled nearly to 36° C. by the temperature controller 160. Thus the temperature of the casting die 81 is kept nearly to 36° C.

Further, the casting controller 79 controls the rotation of the casting drum 82 with the rotary shaft 82a. Thus the rotating speed in the rotary direction Z is kept that the moving speed of the periphery may be in the range of 50 m/min to 200 m/min. Further, the heat transfer medium circulator 89 keeps the temperature T1 of the periphery 82b in the range of −10° C. to 10° C.

The casting die 81 discharges the casting dope 51 from the die outlet 81a. Thus the casting dope 51 is cast onto the periphery 82b of the casting drum 82 so as to form the casting film 53. Then the casting film 53 is cooled down on the periphery 82b such that the gelation proceeds in the casting film 53. Note that the detailed explanation about the discharging of the casting dope 51 from the die outlet 81a will be made later.

The casting film 53, when having the self supporting property, is peeled as the wet film 55 from the casting drum 82 with support of the peel roller 83, and sent by the path rollers 63. Above the path rollers 63, the air blower applies the drying air to the wet film 55 so as dry the wet film 55. Then the wet film 55 is sent to the pin tenter 64.

In the pin tenter 64, both side edge portions are held by the pins at the entrance thereof. The pins move to convey the wet film 55, while the drying is made under a predetermined condition. Then the holding of the wet film 55 is released and transported out as the film 57 to the clip tenter 97. In the clip tenter 97, both side edge portions of the film 57 are clipped by the clips at the entrance thereof. The clips move to convey the film 57, while the drying and the stretching of the film 57 are made under predetermined conditions.

After the drying is made in the pin tenter 64 and the clip tenter 97 such that the content of the remaining solvent may become to a predetermined value, the film 57 is sent to the edge slitting device 65. In the edge slitting device 65, both side edge portions are slit off from the film 57. The slit side edge portions are sent to the crusher 95 by a cutter blower (not shown), and crushed to tips by the crusher 95.

After the slitting, the film 57 is sent to the drying chamber 66, so as to make the drying moreover. Thus the content of the remaining solvent preferably becomes at most 5 wt. %. About the content of the remaining solvent, it was necessary to sample part of the film 57 and dry the sample. If the sample weight at the sampling was x and the sample weight after the drying was y, the solvent content on the dry basis was calculated in the formula, {(x−y)/y}×100. The film 57 is cooled to a room temperature in the cooling chamber 67.

The compulsory neutralization device 104 was provided, such that in the transportation the charged electrostatic potential of the film might be in the range of −3 kV to +3 kV. Further, the film knurling was made on a surface of each side of the film 57 by the knurling roller 105. Then in the winding chamber 68, the film 57 is wound up around the winding shaft 107 while the press roller 108 applies a tension to the film 57 toward the winding shaft 107. It is preferable that the tension is changed gradually from the start to the eng of the winding.

In the present invention, the length of the film 57 is preferably at least 100 m. The width of the film 57 is preferably at least 600 mm, and particularly in the range of 1400 mm to 3000 mm. Further, even if the width is more than 3000 mm, the present invention is effective. Even if the thickness is in the range of 20 μm to 80 μm, the present invention can be preferably applied. Further, if the thickness is in the range of 20 μm to 60 μm, the present invention is particularly preferably applied, and if the thickness is in the range of 20 μm to 40 μm, the present invention is especially preferably applied.

In followings, the casting process 54 will be explained in detail. In FIGS. 4 & 5, the gear pump 73a is driven to feed the first casting dope 51a through the pipe 71a, and the first casting dope 51a enters through the inlet 81a into the manifold 125, and then flow in the slit 126. The gear pump 73b is driven to feed the second casting dope 51b through the pipe 71b to the passage 135, and the second casting dope 51b enters through the outlet 135a into the slit 126, so as to join with the first casting dope 51a. The gear pump 73c is driven to feed the third casting dope 51c through the pipe 71c to the passage 145, and the third casting dope 51c enters through the outlet 145a into the slit 126, so as to join with the first casting dope 51a.

The end 140a of the partitioning portion 140 and the end 150a of the partitioning portion 150 are formed to have an acute angle, and therefore the first and second casting dopes 51a, 51b and the first and third casting dopes 51a, 51c are respectively joined without retaining near the outlets 135a, 145a. Thus the first-third casting dopes 51a-51c are discharged from the outlet 81b, so as to form the casting bead 80. If the ends 140a, 150a don't have the sharp edge, the retaining of the first-third casting dopes 51a-51c sometimes occurs, which causes the generation of the streaks near the interface between the first-third casting dopes 51a-51c. In this case, it is hard to form the casting bead 80 stably.

Since the second and third casting dopes 51b, 51c are fed to the slit by the respective gear pumps 73b, 73c, the flow volumes of each second and third casting dopes 51b, 51c is controlled through the gear pumps 73b, 73c by the casting controller 79. The control of the flow volumes of the second and third casting dopes are made independently from that of the first casting dope 51a, and therefore, the thickness of the side portions of the casting bead 80 can be independently controlled from that of the middle portion.

Thus in the present invention, the thickness of the middle portion (namely the product portion) and the side portion (nonproduct portion) of the film 57 can be independently controlled. Further, since the control of the thickness of the side portions is made by adjusting the flow volumes of the second and third casting dopes 51b, 51c, the thickness of the side portions can be easily controlled adequately without excess and deficiency. Therefore, in the present invention, the film of the predetermined thickness can be effectively produced with preventing the thickness unevenness and the peeling trouble.

The flow volume in width of the first-third casting dope 51a-51c in the pipes 71a-71c is respectively adjusted with use of the gear pumps 73a-73c. The thickness of the side portions is defined to Df1 and the thickness of the middle portion is defined Df2, now. In this case, the value of Df1/Df2 is preferably in the range of 0.75 to 3, and particularly in the range of 1 to 2. Thus the peeling trouble and the thickness unevenness are reduced.

Since the width W1 of the passages 135, 145 is adjusted in the predetermined range, the casting bead 80 is formed stably. The width W1 is preferably at least 0.1 mm. If the width W1 is less than 0.1 mm, the first-third casting dopes 51a-51c cannot join adequately and therefore the casting bead 80 cannot be formed stably. Note that the width W1 may be made larger. In this case, the second and third casting dopes 51b, 51c may form not only the side portion but also the middle portion of the casting bead 80.

Further, the position of the end 140a is adjusted so as to keep the clearance CL1 to the outlet 81b in a predetermined range. Therefore, the second and third casting dopes 51b, 51c are discharged with keeping the pressures thereof.

The clearance CL1 is preferably at most 40 mm. In consideration of the pressure loss at the outlet 81b of the casting die 81, the clearance CL1 is particularly preferably at most 20 mm, especially preferably 5 mm, and more especially preferably 3 mm. In case that the clearance CL1 is more than 40 mm, the flow volumes of the second-third casting dopes 51b, 51c may be not kept until the discharging from the outlet 81b, and as a result, it may become hard to control the thickness of the side portions of the casting bead 80. Further, it is not preferable when the end 140a protrudes out from the casting die 81, namely when the distance from the periphery 82b of the casting drum 81 is smaller to the end 140a than the outlet 81b. In this case, the second and third casting dopes 51b, 51c may be discharged without joining with the first casting dope 51a, and therefore it is hard to form the casting bead 80. Note that the lower limit of the clearance CL1 may be determined on the basis of the processing accuracy of the outlet 81a and the end 140a. For example, the lower limit is preferably 0.1 mm or more.

In this embodiment, the partitioning portions 140, 150 have the same thickness D1. However, the present invention is not restricted in it, and the thickness may be different between partitioning portions 140, 150 in a predetermined range. Further, the ends 140a, 150a have the same clearance to the outlet 81b. However, the present invention is not restricted in it, and the clearance may be different between the ends 140a, 150a.

In the above embodiment, the casting controller 79 is driven to perform the adjustment of the flow volume and the feed of the dope for the side portions. However, the present invention is not restricted in it, and the casting controller may have a function of shifting the partitioning portions such that the clearance between the end of the partitioning portion to the outlet of the casting die.

In the above embodiment, the side portions of the casting bead 80 form both side edge portions of the film 57, and the thickness of the side edge portions is adjusted such that the stability of the casting bead 80 and the peelability of the wet film 55 from the periphery 82b of the casting drum 82 may be increased. However, the present invention is not restricted in it, and the thickness of the side portions may be adjusted such that the transferring ability after the peeling may be increased. Further, when the additives to be added to each first-third casting dope 51a-15c may be chosen adequately, the film 57 produced by the film production line 32 have the predetermined optical properties. For example, the additive for increasing the optical property of the film is added to the first casting dope 51a, and the additive for increasing the peelability and the transferring property after the peeling is added to the second and third casting dopes 51b, 51c. Thus the film excellent in the optical properties can be produced with high productivity.

If the additives for the second and third casting dopes 51b, 51c are adequate for the recycling, it becomes easy to reuse the tips which are obtained by crushing the film fragment with use of the edge slitting device 65 and the crusher 95. The compounds of the additives adequate for the recycling are not restricted especially, so far as easily recycled by the recycling method already known. Concretely, for example, the additive may be easily removed from the dissolution liquid 28 with use of the filtration devices 20, 22.

In the above embodiment, the outlets 135a, 145a of the passages 135, 145 are respectively formed on the contact faces 130b, 131b. However, the outlets 135a, 145a may be formed on the contact faces 130a, 131a.

Further, the contact faces 130b, 131b are formed such that the passage 81c may become continuously wider in the side of the outlet 81b. However, the present invention is not restricted in it, and may be almost constant.

In this embodiment, the passage 136 is formed in the inner deckle plate 130. However, the present invention is not restricted in it. The passage 135 may be formed with use of a member having the partitioning portion 140 and a member having the contact face 130b.

The casting bead 80 sometimes solidifies partially. In this case, the solidified foreign materials are sometimes contained in the film, which causes the defects, such as the decrease of the optical properties. Further, it is not preferable that the casting is made while the foreign materials are attached to the outlet 81b. If the casting is made under this condition, the produced film has streaks on the surface thereof, namely has the surface defect. Therefore, in order to prevent the partial solidification of the casting bead 80, it is preferable that a solution supplying device (not shown) is provided near both sides of the outlet 81b. In this case, a liquid to which the solid materials in the first-third casting dopes 51a-51c are dissolvable is used. The liquid is, for example, a mixture solvent of 86.5 pts.wt. of dichloromethane, 13 pts.wt. of methanol and 0.5 pts.wt. of n-butanol, and is preferably supplied to a gas-liquid interface between the side edges of the casting bead 80 and the slit. Further, the solution preferably contain the good solvent component and the poor solvent component of the polymer of the casting dope.

Note that the pulsating rate of a pump for supplying the liquid is preferably at most 5%. The solution may be used as the second and third casting dopes 51b, 51c. Thus the defect to be caused by the splashing of the solution is prevented, and the defect caused by the foreign materials and the surface unevenness are prevented.

Further, the weight percentage of the poor solvent component in the second and third casting dopes 51b, 51c is defined to HCe, and that in the first solvent 51a is defined to HCc. The value HCe/HCc is preferably in the range of 1.05 to 3. Thus both side edge of the casting film can be easily getlated, and therefore the peelablity is increased. Note that the value HCc is the weight percentage of the poor solvent component to the solvent in the first casting dope 51a, and the value HCe is the weight percentage of the poor solvent component to the solvent in the second and third casting dopes 51b, 51c. Note that the present invention can be applied also when HCc is 0 wt. %.

The estimation whether a component of the solvent is the good solvent component or the poor solvent component can be made as follows. The component and the polymer are mixed such that the weight percentage of the polymer to the total weight may be 5 wt. %. In this case, if part of the polymer don't dissolve to the solvent and remain in the mixture, the component of the solvent is the poor solvent component. If the polymer is entirely dissolved, the component is the good solvent component.

Each first-third casting dopes 51a-51c contains the polymer and the solvent, and furthermore contains additive if necessary. The first-third casting dopes 51a-51c may be the same or may be different. In the case that the first-third casting dopes 51a-51c are the same, the flow volumes of the first-third casting dopes 51a-51c are controlled independently. However, the present invention is not restricted in it. for example, the flow volumes of the first-third casting dopes 51a-51c is controlled depending on the respective contents in the first-third casting dopes 51a-51c. Therefore, the polymer contained in the first casting dope 51a may be the same as and different from that in the second and third casting dopes 51b, 51c. Further, the polymer contained in the second casting dope 51b may be the same as and different from that in the third casting dope 51c. The solvent and the additives contained in the first-third casting dopes 51a-51c may be the same or different.

The solvent contains a good solvent component as the solvent component that the polymer is dissolvable to. The good solvent component may be a mixture of a plurality of materials which is determined as the good solvent component. Further, the solvent may contain both of the good solvent component and the poor solvent component. The poor solvent component may be a mixture of a plurality of materials which is determined as the poor solvent component. Note that the detailed explanation of the good solvent component and the poor solvent component will be made later.

The elongational viscosity of the second casting dope 51b is preferably higher than that of the first casting dope 51a. In this case, the side portions of the casting bead 80 becomes stable, and as a result thereof, the casting bead 80 is prevented from the vibration that is caused by the disorder of the atmosphere, such as the air flow into the driven decompression chamber 165 and the vibration of the support. The elongational viscosity of the first casting dope 51a is described as ηc, and the elongational viscosity of the second casting dope 51b is ηe. The value ηe/ηc is preferably more than 1 and at most 3.

In order to make the elongational viscosity of the second casting dope 51b higher than elongational viscosity of the first casting dope 51a, the content of the poor solvent component to the solvent in the second casting dope 51b is preferably higher than that of the poor solvent component to the solvent in the first casting dope 51a. Furthermore, it is preferable that the content of the polymer in the second casting dope 51b is lower than that of the polymer in the first casting dope 51a. In this case, the damages caused by the neck-in phenomena are reduced. And the decrease of the elongational viscosity is compensated while being caused by the decrease of the content of the polymer. Thus the elongational viscosity of the second casting dope 51b can be increased. Therefore, it is designated to make the casting bead 80 stable with decreasing at the most the damage caused by the neck-in phenomena.

The above conditions of the second casting dope 51b (about the elongational viscosity, the content of the polymer, and the content of the poor solvent component and the like) can be directly applied to the third casting dope 51c. note that the elongational viscosity, the content of the polymer and the content of the poor solvent component may be the same and otherwise different between the second and third casting dopes 51b, 51c.

The elongational viscosity of each first-third casting dope 51a-51c is three times as large as a zero shearing viscosity μ₀, and the zero shearing viscosity μ₀ is given by the measuring method on the standard JIS K 7199.

(Good Solvent Component)

If the polymer is the cellulose acylate, the good solvent components to be used are preferably aromatic hydrocarbons (for example benzene, toluene and the like), hydrocarbon halides (for example, dichloromethane, chlorobenzene and the like), esters (for example, methyl acetate, ethyl acetate, propyl acetates), and ethers (for example, tetrahydrofuran, methylcellosolve and the like).

(Poor Solvent Component)

If the polymer is the cellulose acylate, the poor solvent components to be used are preferably alcohols (for example methanol, ethanol, n-propanol, n-butanol, diethylene glycol and the like), and ketones (for example, acetone, methylethylketone and the like).

Note that the solvent of the dope is the same even if the polymer is other than the cellulose acylate. The poor solvent component and the good solvent component is the solvent component determined by the above method.

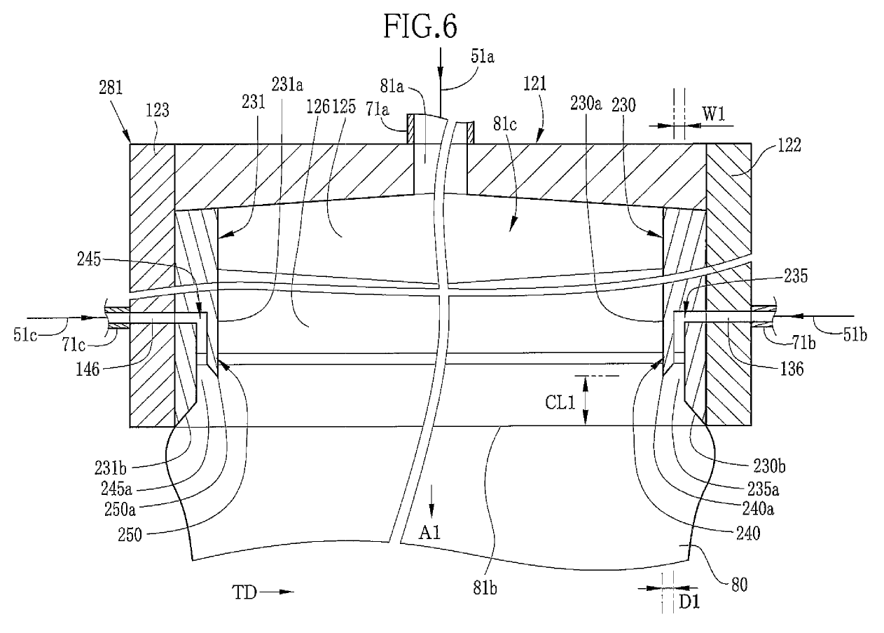

In this embodiment, the partitioning portions 140, 150 have the ends 140a, 150a with the acute angle, while the top of each end 140a, 150a is positioned nearly on a center of the width of each partitioning portion 140, 150 in the direction TD. However, the present invention is not restricted in it. The detailed explanation thereof is made in followings with reference to FIGS. 6-8 illustrating the second-fourth embodiments. Note that the same number is applied to the same member and parts, and the explanation thereof will be omitted.

In FIG. 6, a casting die 281 is constructed of the lip plates 120, 121 and the side plates 122, 123, and has the inlet 81a through which the first casting dope 51a is fed into the casting die 281 from the pipe 71a, and the outlet 81b through which the first-third casting dope 51a-51c are discharged as the casting bead 80 from the casting die 281. In the casting die 281, there are inner deckle plates 230, 231 which are disposed in both sides of the path 81c in the direction TD. The inner deckle plate 230 has contact faces 230a, 230b for contacting to the first-third casting dopes 51a-51c. The inner deckle plate 231 has contact faces 231a, 231b for contacting to the first-third casting dopes 51a-51c. The contact faces 230b, 231b are inclined to the contact faces 230a, 230b such that the path 81c may wider from the inlet 81 to the outlet 81b.

In the inner deckle plate 230 and the side plate 122, a passage 235 and the passage 136 is formed respectively. The passage 136 connects the pipe 71b to the passage 235. The passage 235 has a width W1 and connects the passage 136 to the slit 126. An outlet 235a of the passage 235 is formed on the contact face 230b. The inner deckle plate 230 has the partitioning portion 240 for partitioning the passage 235 and the path 81c. The partitioning portion 240 has an end 240a having acute angle. Near the outlet 235a, the passage 235 becomes gradually wider in the side of the outlet 81b. Further, the end 240a has a clearance CL1 to the outlet 81b.

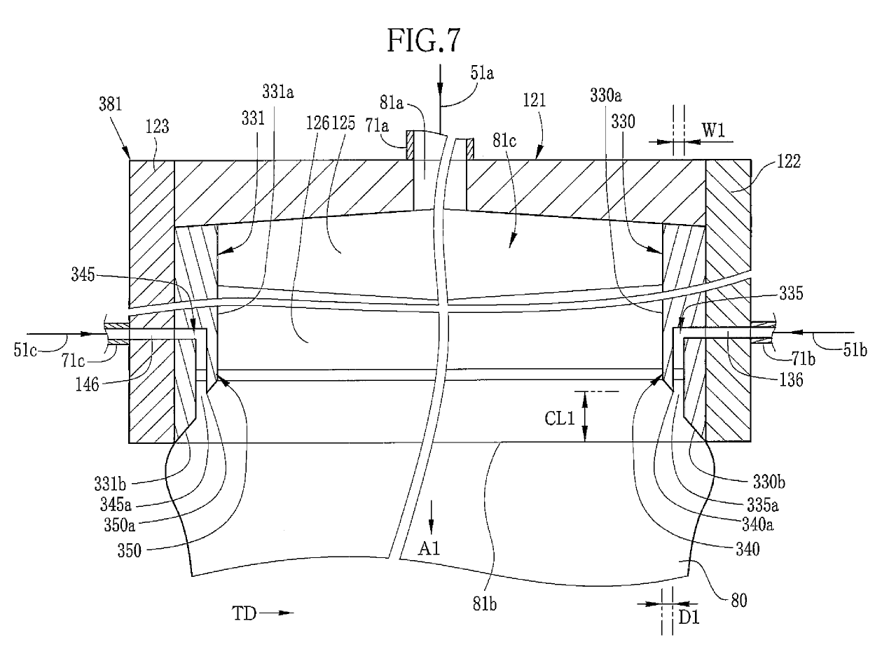

In FIG. 7, a casting die 381 is constructed of the lip plates 120, 121 and the side plates 122, 123, and has the inlet through which the first casting dope 51 is fed into the casting die 381 from the pipe 71a, and the outlet 81b through which the first-third casting dope 51a-51c are discharged as the casting bead 80 from the casting die 381. In the casting die 381, there are inner deckle plates 330, 331 which are disposed in both sides of the path 81c in the direction TD. The inner deckle plate 330 has contact faces 330a, 330b for contacting to the first-third casting dopes 51a-51c. The inner deckle plate 331 has contact faces 331a, 331b for contacting to the first-third casting dopes 51a-51c. The contact faces 330a, 331a are formed such that the width of the path 81c may be almost constant. The contact faces 330b, 331b are inclined to the contact faces 330a, 330b such that the path 81c may wider in the lower side of this figure.

In the inner deckle plate 330 and the side plate 122, a passage 335 and the passage 136 is formed respectively. The passage 136 connects the pipe 71b to the passage 335. The passage 335 has a width W1 and connects the passage 136 to the slit 126. An outlet 335a of the passage 335 is formed on the contact face 330b. The inner deckle plate 330 has the partitioning portion 340 for partitioning the passage 335 and the path 81c. The partitioning portion 340 has an end 340a having acute angle. The passage 335 becomes continuously wider in the side of the outlet 81b. Further, the end 340a has a clearance CL1 to the outlet 81b. The thickness D1 of the partitioning portions 240, 250 in the direction TD is preferably at most 2 mm.

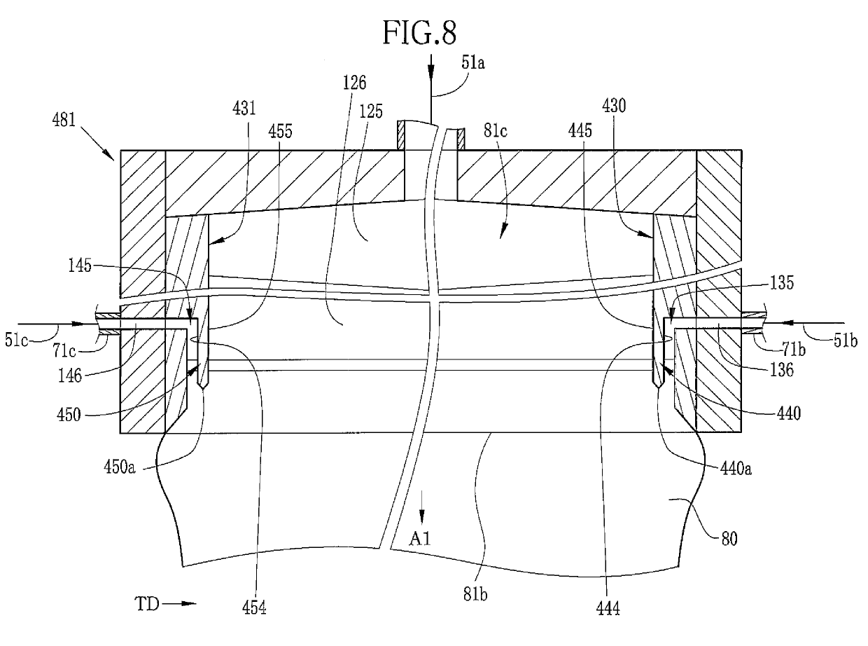

In FIG. 8, a casting die 481 is constructed of the lip plates 120, 121 and the side plates 122, 123, and has the inlet through which the first casting dope 51a is fed into the casting die 481 from the pipe 71a, and the outlet 81b through which the first-third casting dope 51a-51c are discharged as the casting bead 80 from the casting die 481. In the casting die 481, there are inner deckle plates 430, 431 which are disposed in both sides of the path 81c in the direction TD.

The inner deckle plate 430 has the partitioning portion 440 for partitioning the passage 135 and the path 81c. The partitioning portion 440 has an end 440a having acute angle. The end 440a has a clearance CL1 to the outlet 81b. A contact face 444 is formed from the end 440a of the partitioning portion 440 toward an upstream side of the passage 135, and a contact face 445 is formed from the end 440a of the partitioning portion 440 toward an upstream side of the path 81c. The inner deckle plate 431 has the partitioning portion 450 for partitioning the passage 145 and the path 81c. The partitioning portion 450 has an end 450a having acute angle. The end 450a has a clearance CL1 to the outlet 81b. A contact face 454 is formed from the end 450a of the partitioning portion 450 toward an upstream side of the passage 145, and a contact face 455 is formed from the end 450a of the partitioning portion 450 toward an upstream side of the path 81c.

The contact faces 444, 445, 454, 455 are preferably coated with polymers and the like. The polymer is, for example, Teflon (trademark). The thickness of the coating to be formed on the contact faces 444, 445, 454, 455 is determined adequately in accordance with the conditions of the producing processes. Further, the thickness fluctuation of the casting bead 80 in the direction TD has a relationship with the fluctuation of the flowing speed of the first-third casting dopes 51a-51c in the direction TD after the joining. If the flowing speed of the first-third casting dopes 51a-51c is low after the joining, the casting bead 80 is thin. If the flowing speed is high, the casting bead 80 is thick. If the coating of the contact faces 444, 445, 454, 455 of the inner deckle plates 430, 431 with the polymer and the like is made, the unevenness of the flowing speed of the first-third casting dopes 51a-51c in the direction TD after the joining is reduced. Therefore, the casting die 481 casts the first-third casting dopes 51a-51c while the thickness fluctuation of the casting bead in the direction TD is reduced. As a result, the produced film has no or little thickness unevenness in the direction TD.

In the solution casting method of the present invention, there are casting methods for casting plural dopes, for example, a co-casting method and a sequential casting method. In the co-casting method, a feed block may be attached to the casting die as in this embodiment, or a multi-manifold type casting die (not shown) may be used. In the production of the film having multi-layer structure, the plural dopes are cast onto a support to form a casting film having a first layer (uppermost layer) and a second layer (lowermost layer). Then in the produced film, at least one of the thickness of the first layer and that of the lowermost layer opposite thereto is preferably in the range of 0.5% to 30% of the total film thickness. Furthermore, when it is designated to perform the co-casting, a dope of higher viscosity is sandwiched by lower-viscosity dopes. Concretely, it is preferable that the dopes for forming the surface layers have lower viscosity than the dope for forming a layer sandwiched by the surface layers. Further, when the co-casting is designated, it is preferable in the dope bead between a die slit (or die lip) and the support that the composition of alcohol is higher in the two outer dopes than the inner dope.

Japanese Patent Laid-Open Publication No. 2005-104148 describes from [0617] to [0889] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

[Properties & Measuring Method]

(Degree of Curl & Thickness)

Japanese Patent Laid-Open Publication No. 2005-104148 describes from [0112] to [0139] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Curing, Antireflection, Easily Adhesive &

Antiglare Layers)

The cellulose acylate film may be provided with an undercoating layer on at least one of the surfaces, and used in the several ways.

It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

Conditions and Methods for forming the functional layer are described in detail from [0890] to [1087] of Japanese Patent Laid-Open Publication No. 2005-104148, which can be applied to the present invention. Thus, the produced film can have several functions and properties.

These functional layers preferably contain at least one sort of surfactants in the range of 0.1 mg/m² to 1000 mg/m². Further, the functional layers preferably contain at least one sort of plasticizers in the range of 0.1 mg/m² to 1000 mg/m². The functional layers preferably contain at least one sort of matting agents in the range of 0.1 mg/m² to 1000 mg/m². The functional layers preferably contain at least one sort of antistatic agents in the range of 1 mg/m² to 1000 mg/m².

(Variety of Use)

The produced cellulose acylate film can be effectively used as a protection film for a polarizing filter. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No. 2005-104148 discloses the liquid crystal displays of TN type, STN type, VA type, OCB type, reflective type, and other types in detail. The description may be applied to the present invention. Further, in this publication No. 2005-104148 describes a cellulose acylate film provided with an optical anisotropic layer and that having antireflection and antiglare functions. Further, the produced film can be used as an optical compensation film since being double axial cellulose acylate film provided with adequate optical properties. Further, the optical compensation film can be used as a protective film for a polarizing filter. The detail description thereof is made from [1088] to [1265] in the publication No. 2005-104148.

In the method of forming the polymer film of the present invention, the formed cellulose acylate film is excellent in optical properties. The TAC film can be used as the protective film for the polarizing filter, a base film of the photosensitive material, and the like. Further, in order to improve the view angular dependence of the liquid crystal display (used for the television and the like), the produced film can be also used for the optical compensation film. Especially, the produced film is effectively used when it doubles as protective film for the polarizing filter. Therefore, the film is not only used in the TN-mode as prior mode, but also IPS-mode, OCB-mode, VA-mode and the like. Further, the polarizing filter may be constructed so as to have the protective film as construction element.

Further, the present invention is not restricted to the production of the optical film, and applied to the production of any film by the solution casting method. For example, the present invention is applied to the production of a solid electrolyte film as a proton transmitting material to be used for a fuel cell. Note that the polymer to be used in the present invention is not restricted in the cellulose acylate, but may be any polymer already known.

### EXPERIMENT

The experiment of the present invention was made, whose explanation will be made in followings. In this experiment, five examples of the film production were performed. Examples 1-12 were the examples of the present invention, and Comparisons 1-12 were the comparisons to Examples 1-12. The explanation of Example 1 will be made in detail, and the explanation of the same things in the explanations of Examples 2-12 and Comparisons 1-12 will be omitted.

### Example 1

The explanation of Example 1 is made now. The compositions for the preparation of the dope to be used for the film production were as follows:

<Solid Compounds>

| | |
|---|---|
| Cellulose Triacetate | 89.3 wt. % |
| (Degree of substitution, 2.8) | |
| Plasticizer A (triphenyl phosphate) | 7.1 wt. % |
| Plasticizer B (biphenyldiphenyl phosphate) | 3.6 wt. % |

<Mixture Solvent “A”>

| | |
|---|---|
| Dichloromethane (first component of solvent) | 87 wt. % |
| Methanol (second component of solvent) | 12 wt. % |
| n-Butanol (third component of solvent) | 1 wt. % |

The mixture solvent “A” for the dope contained the first and second components of solvent, as described above. The solid compounds were added to the solvent adequately, such that the dope 11 was obtained. Note that the solid content in the obtained dope 11 were 19.3 wt. %. Then the dope 11 was filtrated with use of a filter (#63LB, produced by Toyo Roshi Kaisha, Ltd.), and further filtrated with use of a sintered metallic filter (06N, porous diameter 10 μm, produced by Nippon Seisen, Co., Ltd.). Furthermore, the dope 11 was filtrated with use of a mesh filter, and then stored in the stock tank 30.

<Cellulose Triacetate>

According to cellulose triacetate used in this experiment, the remaining content of acetic acid was at most 0.1 wt. %, the Ca content was 58 ppm, the Mg content was 42 ppm, the Fe content was 0.5 ppm, the free acetic acid was 40 ppm, and the sulfuric ion content was 15 ppm. The degree of acetylation at 6^{th} position was 0.91, and the percentage of acetyl groups at 6^{th} position to the total acetyl groups was 32.5%. The acetone extract was 8 wt. %, and a ratio of weight-average molecular weight to number-average molecular weight was 2.5. Further, yellow index was 1.7, haze was 0.08, and transparency was 93.5%. This cellulose triacetate is synthesized from cellulose as material obtained from cotton, and called cotton TAC in the following explanation.

The film 57 was produced with use of the film production line 32. Each gear pump 73a-73c increased the pressure in the primary side, and the primary dope 48 was fed with a feed back control to the upstream side from the pump with use of an inverter motor, such that the pressure in the primary side may be a predetermined value. Thus the primary dope 48 was fed into the pipes 71a-73a. As for the efficiencies of the gear pumps 73a-73c, the volume efficiency was at most 99.2%, fluctuation percentage of the discharge volume was at most 0.5%. Further, the pressure for discharging was 1.5 MPa. The casting controller 79 drove and controlled the gear pumps 73a-73c to feed the primary dope 48 to the static mixers 75a-75c. In the filtration devices 74a-74c, the filtration of the primary dope 48 was made.

In the additive supplying line, the mixture additive was fed into the pipes 71a-71c. Thereafter the mixture of the mixture additive and the primary dope 48 was stirred by the static mixers 75a-75c.

The casting die 81 included the lip plates 120, 121, the side plates 122, 123, the inner deckle plates 130, 131, while these members of the casting die 81 was formed of stainless whose percentage of the volume change was 0.002%. As for the finish accuracy of the contact faces 120a, 120b, 121a-121d, 130a, 130b, 131a, 131b of the lip plates 120, 121 and the inner deckle plates 130, 131, the surface roughness was at most 1 μm and the straightness was at most 1 μm/m in any directions. During the casting, the flow volume of each first-third casting dope 51a-51c was controlled and the slit width SW1, SW2 was adjusted, such that the thickness of the dried film 57 might be 80 μm. The temperature of a heat transfer medium was controlled to 36° C. at the entrance of a jacket (not shown) of the casting die 81, such that the temperature of the first-third casting dopes 51a-51c might be controlled to 36° C. The width W1 of the passages 135, 145 was 5 mm, and each clearance CL1 between the end 140a and the outlet 81b and between the end 140a and the outlet 81b was 2 mm. Further, each thickness D1 of the partitioning portions 140, 150 was 2 mm.

In this experiment, the sizes of the lip plates 120, 121 and the inner deckle plates 130, 131 and the change of the sizes were measured with use of a microscope whose resolution was 1 μm.

The temperatures of casting die 81 and the pipe 71a-71c were controlled to 36° C. during the film production. The casting die 81 was the coat hunger type, in which heat bolts for adjusting the film thickness were disposed at the pitch of 20 mm. Thus the film thickness (or the thickness of the discharged casting dopes) is automatically controlled by the heat bolt. A profile of the heat volt can be set corresponding to the flow volume of the gear pumps 73a-73c, on the basis of the preset program. Thus the feed back control can be made by the control program on the basis of the profile of an infrared ray thickness meter (not shown) disposed in the film production line 32. The control was made such that, with exception of both side edge portions (20 mm each in the widthwise direction of the produced film), the difference of the film thickness between two positions (50 mm apart from each other) might be at most 1 μm, and the difference between the largest value and minimal value of the film thickness in the widthwise direction might be at most 3 μm/m. Further, the average film thickness might was controlled in ±1.5%.

The primary side (namely the upstream side) of the casting die 81 is provided with the decompression chamber 165. The decompression rate of the decompression chamber 165 was controlled in accordance with the casting speed, such that the pressure difference might occur in the range of one Pa to 5000 Pa between the upstream and downstream sides of the dope bead of the discharged casting dope above the casting drum 82. At this time, the pressure difference between both sides of the dope bead was determined such that the length of the dope bead might be from 20 mm to 50 mm. Further, a jacket (not shown) was attached such that the inner temperature of the decompression chamber might be constant, and the inside of the jacket was supplied with a temperature transfer medium whose temperature was controlled to 35° C. Further, there was labyrinth packing (not shown) in the upstream and downstream sides of the dope beads.

The material of the lip plates 120, 121, the side plates 122, 123, and the inner deckle plates 130, 131 was the stainless steel, whose coefficient of thermal expansion was at most 2×10⁻⁵ (° C.⁻¹). In the compulsory corrosion experiment in an electrolyte solution, the corrosion resistance was almost the same as that of SUS316. Further, the material to be used for the casting die 81 had enough corrosion resistance, such that the pitting (or pitting corrosion) might not occur on the gas-liquid interface even if this material were dipped in a mixture liquid of dichloromethane, methanol and water for three months. The finish accuracy of the contact surface of each casting die 81 to the casting dope 51 was at most 1 μm in surface roughness, the straightness 1 μm/m was in any direction, and the slit clearance was adjusted to 1.5 mm in straightness. According to an edge of the contact portion of a lip end of the casting die 81, R is at most 50 μm in all of a width. Further, the shearing rate in the casting die 81 controlled in the range of one to 5000 per second. Further, the WC coating was made on the lip end from the casting die 81 by a melt extrusion method, so as to provide the hardened layer.

The casting drum 82 was a stainless drum which was 3.0 m in width. The surface of the casting drum 82 was polished, such that the surface roughness might be at most 0.05 μm. The material was SUS316, which had enough corrosion resistance and strength. The thickness unevenness of the entire casting drum 82 was at most 0.5% of the predetermined value. The shaft 82a is driven under the control of the casting controller 79 to rotate the casting drum 82. The casting speed, namely the moving speed of the periphery 82b in the rotary direction Z1 is in the range of 50 m/min to 200 m/min. Further the control was made such that the variation of the speed of the casting drum 82 was at most 0.5% to the predetermined value. The position of the belt in the widthwise direction was controlled with detection of the position of the side end, such that meandering in one circle of the casting drum 82 which is running was reduced in 1.5 mm. Further, below the casting die 81, the variation of the position in the vertical direction between the lip end of the casting die 81 and the casting drum 82 was in 200 μm. The casting drum 82 is disposed in the casting chamber 62 including an air pressure controlling device (not shown).

In this experiment, the casting drum 82 was supplied therein with a heat transfer medium, such that the temperature T1 of the periphery 82b might be controlled. The casting drum 82 was supplied with the heat transfer medium (water) at a temperature in the range of −10° C. to 10° C. The surface temperature of the middle portion of the casting drum 82 at a position just before the casting was 0° C., and the temperature difference between both sides of the casting drum 82 was at most 6° C. Note that a number of pinhole (diameter, at least 30 μm) was zero, a number of pinhole (diameter, at least 10 μm and less than 30 μm) was at most one in square meter, and a number of pinhole (diameter, less than 10 μm) was at most two in square meter.

Note that the oxygen concentration in the drying atmosphere on the casting drum 82 was kept to 5 vol % by substituting the air for nitrogen gas. In order to keep the oxygen concentration to 5 vol %, the inner air of the drying atmosphere was substituted by nitrogen gas. The solvent vapor in the casting chamber 62 was recovered by setting the temperature of exit of the condenser 87 to −3° C. The static fluctuation near the casting die 81 was reduced to at most ±1 Pa.

While the first-third casting dopes 51a-51c was cast from the casting die 81 onto the casting drum 82, the dope bead 80 was formed between the die outlet 81a and the periphery 82b. Further, the solution of the dichloromethane (50 wt. %) and the methanol (50 wt. %) was supplied around the constant flow volume to the edge sides of the dope bead 80. Thus the decompression chamber 165 decompressed a rear side of the casting bead 80, and the discharged dope formed the casting film 53 on the casting drum 82. Then the casting film 50 was cooled down. When the casting film 53 has the self-supporting property, the casting film 53 was peeled as the wet film 55 from the casting drum 82 with support of the peel roller 83. In order to reduce the peeling troubles, the percentage of the peeling speed (the draw of the peeling roller 83) to the speed of the casting drum 82 was controlled from 100.1% to 110%. The solvent vapor generated in the evaporation is condensed by the condenser 87 at −3° C. to a liquid state, and recovered by the recovering device 88. The water content of the recovered solvent was adjusted to at most 0.5%. Further, the air from which the solvent components were removed was heated again and reused for the drying air. The wet film 55 was transported with the path rollers 63 toward the pin tenter 64. Above the path rollers 63, the drying air at 60° C. was fed to the wet film 55 from the air blower.

In the pin tenter 64, both side edge portions of the wet film 55 were kept by the pins, and the wet film 55 was transported through the temperature zones sequentially. During the transport in the pin tenter 64, the predetermined drying was made to the wet film 55, such that the content of the remaining solvent might be at most 5 wt. %. Thereafter the wet film 55 was fed out as the film 57 from the pin tenter 64 to the edge slitting device 65.

The solvent vapor evaporated in the pin tenter 64 was condensed and liquidized at −3° C. by a condenser (not shown) for recovery of the solvent. Thereafter the water content of the recovered solvent was adjusted to at most 0.5 wt. %.

In 30 seconds from exit of the pin tenter 64, both side edge portions were slit off in the edge slitting device 65. In this experiment, each side portion of 50 mm in the widthwise direction of the film 57 was determined as the side edge portion, which were slit off by an NT type slitter of the edge slitting device 65. The slit side edge portions were sent to the crusher 95 by applying air blow from a blower (not shown), and crushed to tips about 80 mm². The tips were reused as raw material with the TAC flake for the dope production. Before the drying at the high temperature in the drying chamber 66, the pre-heating of the film 57 was made in a pre-heating chamber (not shown in which the air blow at 100° C. was supplied.

The film 57 was dried at high temperature in the drying chamber 66, which was partitioned into four areas. Air blows whose temperatures were 120° C., 130° C., 130° C. and 130° C. from the upstream side were fed from air blowers (not shown) to the areas. The transporting tension of each roller 100 to the film 57 was 100 N/m. The drying was made for 5 minutes such that the content of the remaining solvent might be 0.3 wt. %. The lapping angle of the roller 4 was 80° and 190°. The rollers 100 were made of aluminum or carbon steel. On the surface, the hard chrome coating was made. The surfaces of the rollers 100 were flat dimples or processed by for example blast of matting process. The fluctuation of the film 57 was in 50 μm during the rotation of the rollers. The swing of the roller in the rotation was in 50 μm. Further, the bending of the roller 100 at the tension of 100 N/m was reduced to at most 0.5 mm.

The solvent vapor contained in the drying air is removed with use of the adsorbing device 101 in which an adsorbing agent was used. The adsorbing agent was active carbon, and the desorption was performed with use of dried nitrogen. The recovered solvent was reuse as the solvent for the dope preparation after the water content might be at most 0.3 wt. %. The drying air contains not only the solvent vapor but also gasses of the plasticizer, UV-absorbing agent, and materials of high boiling points. Therefore, a cooler for removing by cooling and a preadsorber were used to remove them. Thus the drying air was reused. The ad- and desorption condition was set such that a content of VOC (volatile organic compound) in exhaust gas might be at most 10 ppm. Furthermore, in the entire solvent vapor, the solvent content to be recovered by condensation method was 90 wt. %, and almost of the remaining solvent vapor was recovered by the adsorption recovering.

The film 57 was transported to a first moisture controlling chamber (not shown). In the interval section between the drying chamber 66 and the first moisture controlling chamber, the drying air at 110° C. was fed. In the first moisture controlling chamber, the air whose temperature was 50° C. and dewing point was 20° C. was fed. Further, the film 57 was fed into a second moisture chamber (not shown) in which the curling of the film 57 was reduced. An air whose temperature was 90° C. and humidity was 70% was applied to the film 57 in the second moisture controlling chamber.

After the moisture adjustment, the film 57 was cooled to 30° C. in the cooling chamber 67, and then the edge slitting was performed. The compulsory neutralization device (or a neutralization bar) 104, was provided, such that in the transportation, the charged electrostatic potential of the film might be in the range of −3 kV to +3 kV. Further, the film knurling was made on a surface of each side of the film 57 by the knurling roller 105. The width of the knurling was 10 mm, and the knurling pressure was set such that the maximal thickness might be at most 12 μm larger in average than the averaged thickness.

The film 57 was transported to a winding chamber 68, whose inside temperature and humidity were respectively kept to 28° C. and 70%. Further, a compulsory neutralization device (not shown) was provided, such that the charged electrostatic potential of the film might be in the range of −1.5 kV to +1.5 kV. The film 57 is wound up around the winding shaft 107 in the casting chamber by pressing the film 57 by the press roller 108.

### Example 2

The conditions of the flow volumes of the first-third casting dopes 51a-51c fed by the gear pumps 73a-73c were changed such that the thickness Df1 of the film 57 might be 70 μm. Other conditions were the same as in Example 1.

### Example 3

The conditions of the flow volumes of the first-third casting dopes 51a-51c fed by the gear pumps 73a-73c were changed such that the thickness Df1 of the film 57 might be 60 μm. Other conditions were the same as in Example 1.

### Example 4

The conditions of the flow volumes of the first-third casting dopes 51a-51c fed by the gear pumps 73a-73c were changed such that the thickness Df1 of the film 57 might be 55 μm. Other conditions were the same as in Example 1.

### Example 5

The conditions of the flow volumes of the first-third casting dopes 51a-51c fed by the gear pumps 73a-73c were changed such that the thickness Df1 of the film 57 might be 50 μm. Other conditions were the same as in Example 1.

### Example 6

The conditions of the flow volumes of the first-third casting dopes 51a-51c fed by the gear pumps 73a-73c were changed such that the thickness Df1 of the film 57 might be 40 μm. Other conditions were the same as in Example 1.

[Comparisons 1-6]

The prior inner deckle plates having no passages 135, 145 were used instead of the inner deckle plates 130, 131. Other conditions of Comparisons 1-6 were respectively the same as Examples 1-6.

[Film Estimation]

In the examples of the above experiment, the estimation of the film was made in the points of thickness unevenness caused by the entrance of the entrained air and the unstableness of the casting bead. The estimation was made in the following manner, which was the same among Examples 1-6 and Comparisons 1-6. The result of the film estimation is shown in Table 1.

1. About Peeling Trouble (PD):

When the peeling of the casting film 53 from the periphery 82b was performed, it was observed with eyes whether part of the casting film 53 remained on the periphery 82b. The estimations were as follows;

A. Part of casting film 53 didn't remain;

E. Part of casting film 53 remained.

2. About the Thickness Unevenness (TU):

The film thickness of the obtained film was measured at five points on the film at 25° C. and 60 RH %, with use of an electronic micrometer (produced by Anritsu Corporation). Then the relative standard deviation RSD was calculated from the average and the deviation of values obtained by the measurement, as follows:

RSD(%)=(Deviation/Average)×100

On the base of the value of RSD, the estimation of the thickness unevenness was made as follows;
A. thickness unevenness was less than 10%, and the thickness uniformity is excellent;
E. thickness unevenness was 10% or more, and the thickness unevenness are too much.

3. About Production Adequacy (PA):

The time T1 which it took for adjusting the thickness of the side portions of the casting bead 80 was measured. The production adequacy was represented as the percentage of the time T1 to the prior time for adjusting the thickness of the side portion in the prior art. The estimation was made as follows.
A. the time T1 was less than 20% of the prior time;
B. the time was at least 20% and less than 100% of the prior time;
E. the time was at least 100% of the prior time.

[Table 1]

TABLE 1

| | Df1 | Df2 | Estimations | | |
|---|---|---|---|---|---|
| | (μm) | (μm) | PD | TU | PA |
| Ex. 1 | 80 | 80 | A | A | A |
| Ex. 2 | 70 | 70 | A | A | A |
| Ex. 3 | 60 | 60 | A | A | A |
| Ex. 4 | 55 | 55 | A | A | A |
| Ex. 5 | 50 | 50 | A | A | A |
| Ex. 6 | 40 | 40 | A | A | A |
| Co. 1 | 80 | 80 | A | A | E |
| Co. 2 | 70 | 70 | A | A | E |
| Co. 3 | 60 | 60 | A | A | E |
| Co. 4 | 55 | 55 | E | E | E |
| Co. 5 | 50 | 50 | E | E | E |
| Co. 6 | 40 | 40 | E | E | E |

### Example 7

The conditions of the flow volumes of the first-third casting dopes 51a-51c fed by the gear pumps 73a-73c were changed such that the thickness Df1 of the middle portion of the film 57 might be 80 μm and the thickness Df2 of both side edge portions might be in the range of 80 μm to 160 μm. Other conditions were the same as in Example 1.

### Example 8

The conditions of the flow volumes of the first-third casting dopes 51a-51c fed by the gear pumps 73a-73c were changed such that the thickness Df1 of the middle portion of the film 57 might be 70 μm and the thickness Df2 of both side edge portions might be in the range of 70 μm to 140 μm. Other conditions were the same as in Example 1.

### Example 9

The conditions of the flow volumes of the first-third casting dopes 51a-51c fed by the gear pumps 73a-73c were changed such that the thickness Df1 of the middle portion of the film 57 might be 60 μm and the thickness Df2 of both side edge portions might be in the range of 60 μm to 120 μm. Other conditions were the same as in Example 1.

### Example 101

The conditions of the flow volumes of the first-third casting dopes 51a-51c fed by the gear pumps 73a-73c were changed such that the thickness Df1 of the middle portion of the film 57 might be 55 μm and the thickness Df2 of both side edge portions might be in the range of 55 μm to 110 μm. Other conditions were the same as in Example 1.

### Example 11

The conditions of the flow volumes of the first-third casting dopes 51a-51c fed by the gear pumps 73a-73c were changed such that the thickness Df1 of the middle portion of the film 57 might be 50 μm and the thickness Df2 of both side edge portions might be in the range of 50 μm to 100 μm. Other conditions were the same as in Example 1.

### Example 12

The conditions of the flow volumes of the first-third casting dopes 51a-51c fed by the gear pumps 73a-73c were changed such that the thickness Df1 of the middle portion of the film 57 might be 40 μm and the thickness Df2 of both side edge portions might be in the range of 40 μm to 80 μm. Other conditions were the same as in Example 1.

[Comparisons 7-12]

The prior inner deckle plates having no passages 135, 145 were used instead of the inner deckle plates 130, 131. Other conditions of Comparisons 7-12 were respectively the same as Examples 7-12.

In Examples 7-12, the peeling trouble and the thickness unevenness didn't occur. However, in Comparisons 7-12, the thickness of the side portions could not be controlled to the predetermined value, and the peeling trouble or the thickness unevenness occurred.

As known from Table 1 clearly, in Examples 1-6 and Comparisons 1-6, since the casting die of the present invention is used, the occurrence of the thickness unevenness and the peeling trouble were reduced. Especially, when it is designated to produce the thin film whose thickness Df1 is less than 60 μm, the effect of the present invention is very large. Further, since the flow volumes of the casting dopes for forming the side portions and the flow volume of the casting dope for forming the middle portion was controlled independently, it took a shorter time T1 than the prior art to adjust the thickness of the side portions. Further, in Examples 7-12 and Comparisons 7-12, the thickness of the side portions is at least the same and at most twice as large as the thickness of the middle portion, and the thickness unevenness and the peeling trouble didn't occur. Thus the adjustment of the thickness of the side portions became easy.

### Example 13

The explanation of Example 13 is made now. The solid compounds of Example 1 were added to a mixture solvent of the following compositions, so as to obtain a primary dope of second-component:

<Mixture Solvent “B”>

<Mixture Solvent “B”>

| | |
|---|---|
| Dichloromethane (first component of solvent) | 74 wt. % |
| Methanol (second component of solvent) | 24 wt. % |
| n-Butanol (third component of solvent) | 2 wt. % |

The primary dope of second component was used instead of the primary dope 48, so as to obtain the second and third casting dopes 51b, 51c. The conditions of the flow volumes of the first-third casting dopes 51a-51c fed by the gear pumps 73a-73c were changed such that the thickness Df1 of the middle portion of the film 57 might be 80 μm and the thickness Df2 of both side edge portions might be 80 μm. Other conditions were the same as in Example 1.

### Examples 14-18

The conditions of the flow volumes of the first-third casting dopes 51a-51c fed by the gear pumps 73a-73c were changed such that the thickness Df1 and the thickness Df2 may be the predetermined values. Other conditions were the same as Example 13. The values of the thickness Df1, Df2 are shown in Table 2.

[Comparisons 13-18]

The prior inner deckle plates having no passages 135, 145 were used instead of the inner deckle plates 130, 131. The primary dope 48 was used for preparing the second and third casting dopes 51b, 51c, instead of using the primary dope of second component. Other conditions of Comparisons 13-18 were respectively the same as Examples 13-18. The values of the thickness Df1, Df2 are shown in Table 2.

In Table 2 according to Examples 13-18 and Comparisons 13-18 are shown the values HCe/HCc, the thickness Df1 of the middle portion and the thickness Df2 of the side portions of the film. The value HCe/HCc is a content ratio when the content of the poor solvent component to the solvent in the second and third casting dope 51b, 51c is describes as HCe and the content of the poor solvent component in the first dope 51a is described as HCc. Further, the estimations of the peeling trouble (PD), the thickness unevenness (TU) and the production adequacy (PA) are also shown.

[Table 2]

TABLE 2

| | | Df1 | Df2 | Estimations | | |
|---|---|---|---|---|---|---|
| | HCe/HCc | (μm) | (μm) | PD | TU | PA |
| Ex. 13 | 2.0 | 80 | 80 | A | A | A |
| Ex. 14 | 2.0 | 70 | 70 | A | A | A |
| Ex. 15 | 2.0 | 60 | 60 | A | A | A |
| Ex. 16 | 2.0 | 55 | 55 | A | A | A |
| Ex. 17 | 2.0 | 50 | 50 | A | A | A |
| Ex. 18 | 2.0 | 40 | 40 | A | A | A |
| Co. 13 | 1.0 | 80 | 80 | E | E | E |
| Co. 14 | 1.0 | 70 | 70 | E | E | E |
| Co. 15 | 1.0 | 60 | 60 | E | E | E |
| Co. 16 | 1.0 | 55 | 55 | E | E | E |
| Co. 17 | 1.0 | 50 | 50 | E | E | E |
| Co. 18 | 1.0 | 40 | 40 | E | E | E |

In the following examples,

the mixture solvent C is different from the mixture solvents A and B;

the mixture solvent D is different from the mixture solvents A, B and C;

the mixture solvent E is different from the mixture solvents A, B, C and D; and

the mixture solvent F is different from the mixture solvents A, B, C, D and E.

### Examples 19-24

The solid compounds of Example 1 were added to a mixture solvent C, so as to obtain a primary dope 48 of third-component. The primary dope 48 of third-component was used for preparing the first casting dope 51a.

Then the solid compounds of Example 1 were added to a mixture solvent D, so as to obtain a primary dope of fourth-component. The primary dope 48 of fourth-component was used for preparing the second and third casting dopes 51b, 51c.

The elongational viscosity of the primary dope of the third-component is described as ηc, while the primary dope is used for the first casing dope 51, and the elongational viscosity of the primary dope of the fourth-component is described as ηe, while the primary dope is used for the second and third casting dopes 51b, 51c. The elongational viscosities were measured, and the value of ηe/ηc was 1.5. Then the first casting dope 51a obtained from the primary dope of third-component and the second and third casting dopes 51b, 51c obtained from the primary dope of fourth-component were used for the film production. The conditions of the flow volumes of the first-third casting dopes 51a-51c fed by the gear pumps 73a-73c were changed such that the thickness Df1 and the thickness Df2 may be the predetermined values. Other conditions were the same as Example 13. The values of the thickness Df1, Df2 are shown in Table 3.

[Comparisons 19-24]

The prior inner deckle plates having no passages 135, 145 were used instead of the inner deckle plates 130, 131. The primary dope of third component was used for preparing the first-third casting dopes 51a-51c. Other conditions of Comparisons 19-24 were respectively the same as Examples 19-24. The values of the thickness Df1, Df2 are shown in Table 3.

In Table 3 according to Examples 19-24 and Comparisons 19-24 are shown the values ηe/ηc, the thickness Df1 of the middle portion and the thickness Df2 of the side portions of the film. The value ηe/ηc is a content ratio when the elongational viscosity of each second and third casting dope 51b, 51c is describes as ηe and the elongational viscosity of the first dope 51a is described as ηc. Further, the estimations of the peeling trouble (PD), the thickness unevenness (TU) and the production adequacy (PA) are also shown.

[Table 3]

TABLE 3

| | | Df1 | Df2 | Estimations | | |
|---|---|---|---|---|---|---|
| | ηe/ηc | (μm) | (μm) | PD | TU | PA |
| Ex. 19 | 1.5 | 80 | 80 | A | A | A |
| Ex. 20 | 1.5 | 70 | 70 | A | A | A |
| Ex. 21 | 1.5 | 60 | 60 | A | A | A |
| Ex. 22 | 1.5 | 55 | 55 | A | A | A |
| Ex. 23 | 1.5 | 50 | 50 | A | A | A |
| Ex. 24 | 1.5 | 40 | 40 | A | A | A |
| Co. 13 | 1.0 | 80 | 80 | A | A | E |
| Co. 19 | 1.0 | 70 | 70 | A | A | E |
| Co. 21 | 1.0 | 60 | 60 | A | A | E |
| Co. 22 | 1.0 | 55 | 55 | E | E | E |
| Co. 23 | 1.0 | 50 | 50 | E | E | E |
| Co. 24 | 1.0 | 40 | 40 | E | E | E |

### Examples 25-30

The solid compounds of Example 1 were added to a mixture solvent E, so as to obtain the primary dope 48 of fifth-component. The primary dope of fifth-component was used for preparing the first casting dope 51a.

Then the solid compounds of Example 1 were added to a mixture solvent F, so as to obtain the primary dope 48 of sixth-component. The primary dope 48 of sixth-component was used for preparing the second and third casting dopes 51b-51c.

Then the first casting dope 51a obtained from the primary dope of the fifth component and the second and third casting dopes 51b, 51c obtained from the primary dope of the sixth component were used for the film production. The conditions of the flow volumes of the first-third casting dopes 51a-51c fed by the gear pumps 73a-73c were changed such that the thickness Df1 and the thickness Df2 may be the predetermined values. Other conditions were the same as Example 13. The values of the thickness Df1, Df2 are shown in Table 4.

[Comparisons 25-30]

The prior inner deckle plates having no passages 135, 145 were used instead of the inner deckle plates 130, 131. The primary dope of third component was used for preparing the first-third casting dopes 51a-51c. Other conditions of Comparisons 25-30 were respectively the same as Examples 25-30. The values of the thickness Df1, Df2 are shown in Table 4.

In Table 4 according to Examples 25-30 and Comparisons 25-30 are shown the values PCe/PCc, HCe/HCc, Df1 and Df2. Herein, the value PCe is a concentration of the polymer in the first dope 51a, and the value PCc is a concentration of the polymer in the second and third dopes 51b, 51c. Further, the estimations of the peeling trouble (PD), the thickness unevenness (TU) and the production adequacy (PA) are also shown.

[Table 4]

TABLE 4

| | | | Df1 | Df2 | Estimations | | |
|---|---|---|---|---|---|---|---|
| | PCe/PCc | HCe/HCc | (μm) | (μm) | PD | TU | PA |
| Ex. 25 | 0.85 | 2.0 | 80 | 80 | A | A | A |
| Ex. 26 | 0.85 | 2.0 | 70 | 70 | A | A | A |
| Ex. 27 | 0.85 | 2.0 | 60 | 60 | A | A | A |
| Ex. 28 | 0.85 | 2.0 | 55 | 55 | A | A | A |
| Ex. 29 | 0.85 | 2.0 | 50 | 50 | A | A | A |
| Ex. 30 | 0.85 | 2.0 | 40 | 40 | A | A | A |
| Co. 25 | 0.85 | 2.0 | 80 | 80 | A | A | E |
| Co. 26 | 0.85 | 2.0 | 70 | 70 | A | A | E |
| Co. 27 | 0.85 | 2.0 | 60 | 60 | A | A | E |
| Co. 28 | 0.85 | 2.0 | 55 | 55 | E | E | E |
| Co. 29 | 0.85 | 2.0 | 50 | 50 | E | E | E |
| Co. 30 | 0.85 | 2.0 | 40 | 40 | E | E | E |

In the inner deckle plates 430, 431 of the casting die 481, the contact faces 444, 445, 454, 455 are coated with Teflon. In the performing of the film production, other conditions were the same as Example 1. According to the obtained film, the relative standard deviation (RSD) in Example 1 was the largest from others.

Accordingly, in the solution casting method and the solution casting apparatus of the present invention, since the thickness of the side portions of the casting bead is controlled independently from that of the middle portion, the thin film and the wide film can be produced effectively.

Various changes and modifications are possible in the present invention and may be understood to be within the present invention.

What is claimed is:

1. A dope applying method for forming a casting film on a moving support, said casting film being to be dried to a polymer film, said dope applying method comprising steps of:
(1) preparing a side dope for composing a side portion of a bead from a casting die to said support, said casting die discharging said side dope through a slit extending in a widthwise direction of said support;
(2) preparing a middle dope for composing a middle portion between said side portions of said bead;
(3) joining flows of said side dopes and said middle dope in said casting die, said casting die having a partitioning member with cutout such that said partitioning member may form a side flow passage for flowing said side dope and a middle flow passage for flowing said middle dope, a downstream end of said partitioning member being disposed in an upstream from said slit such that said side dopes and said middle dope may join before the flowing out from the slit; and
(4) making a co-application of said side dopes and said middle dope.

2. A dope casting method as described in claim 1, wherein a distance from said outlet to said downstream end is in the range of 0.1 mm to 40 mm.

3. A dope casting method as described in claim 1, wherein a width W1 of said side flow passage in a lengthwise direction of said slit is at least 0.1 mm.

4. A dope casting method as described in claim 1, wherein said side dope is supplied to said side feed passage by a side feeding device for feeding said side dope.

5. A dope casting method as described in claim 4r
wherein said middle dope is supplied to said middle flow passage by a middle feeding device for feeding said middle dope; and
wherein a flow volume is independently controlled between said side dope flowing in said side flow passage and said middle dope flowing in said middle flow passage with use of said side feeding device and said middle feeding device.

6. A dope casting method as described in claim 1, wherein said middle dope, a first side dope to be supplied to one of said side flow passages, and a second side dope to be supplied to another one of said side flow passages are the same.

7. A dope casting method as described in claim 1, wherein elongation viscosity of said side dope is higher than that of said middle dope.

8. A dope casting method as described in claim 7, wherein, if said elongational viscosity of said side dope is ηe and said elongational viscosity of said middle dope is ηc, a value of ηe/ηc is at most 3.

9. A dope casting method as described in claim 7,
wherein each solvent of said middle dope and said side dope contains a good solvent component and a poor solvent component; and
wherein a content of said poor solvent component to said solvent in said side dope is higher than a content of said poor solvent component to said solvent in said middle dope.

10. A dope casting method as described in claim 9, wherein a content of said polymer in said side dope is lower than a content of said polymer in said middle dope.

11. A dope casting method as described in claim 1, wherein said partitioning portion has at least a contact face for contacting one of said middle dope and a side dope, and said contact face is coated with a high molecular compound.

12. A solution casting method of applying a dope on a moving support so as to produce polymer film, comprising steps of:
(1) preparing a side dope for composing a side portion of a bead from a casting die to said support, said casting die discharging said side dope through a slit extending in a widthwise direction of said support;
(2) preparing a middle dope for composing a middle portion between said side portions of said bead;
(3) joining flows of said side dopes and said middle dope in said casting die, said casting die having a partitioning member with cutout such that said partitioning member may form a side flow passage for flowing said side dope and a middle flow passage for flowing said middle dope, a downstream end of said partitioning member being disposed in an upstream from said slit such that said side dopes and said middle dope may join before the flowing out from the slit;
(4) making a co-application of said side dopes and said middle dope;
(5) peeling said casting film as said polymer film from said support, after said casting film has a self-supporting properties; and
(6) drying said polymer film.

13. A casting unit for applying a dope with forming a bead on a moving support, comprising:
a casting die for discharging said dope, said casting die being provided with a side inlet for supplying a side dope to compose a side portion of said bead, a middle inlet for supplying a middle dope to compose a middle portion between said side portions, a slot for flowing said side dope and said middle dope, a slit for making a co-discharging of said side dope and said middle dope, and a manifold for retaining said middle dope;
a partitioning portion disposed in said slot, said partitioning portion partitioning said slot into a side flow passage for flowing said side dope and a middle flow passage for flowing said middle dope, a downstream end of said partitioning portion having a cutoff with acute angle, said cutoff being disposed in the range of 0.1 mm to 40 mm in an upstream side from said slit, and
a feeding device for feeding said side dope to said side inlet.

14. A casting unit as described in claim 13, wherein a width W1 of said side flow passage in a lengthwise direction of said slit is at least 0.1 mm.

15. A casting unit as described in claim 13, wherein said side dope is supplied to said side feed passage by a side feeding device for feeding said side dope.

16. A casting unit as described in claim 15,
wherein said middle dope is supplied to said middle flow passage by a middle feeding device for feeding said middle dope; and
wherein a flow volume is independently controlled between said side dope flowing in said side flow passage and said middle dope flowing in said middle flow passage with use of said side feeding device and said middle feeding device.

17. A casting unit as described in claim 15, wherein said partitioning portion has at least a contact face for contacting one of said middle dope and a side dope, and said contact face is coated with a high molecular compound.
